(19) United States
(12) Patent Application Publication
(10) Pub. No.: US 2023/0209220 A1
(43) Pub. Date: Jun. 29, 2023

(54) IMAGE PROCESSING DEVICE, IMAGE PROCESSING METHOD, AND IMAGE PROCESSING PROGRAM

(71) Applicant: SONY GROUP CORPORATION, TOKYO (JP)

(72) Inventor: KENICHI NISHIO, TOKYO (JP)

(21) Appl. No.: 18/001,061

(22) PCT Filed: Jun. 8, 2021
(86) PCT No.: PCT/JP2021/021657

§ 371 Date: Dec. 7, 2022

(30) Foreign Application Priority Data
Jun. 17, 2020 (JP) 2020-104337

(51) Int. Cl. H04N 25/683; H04N 25/48; H04N 17/00; H04N 23/84

(52) U.S. Cl. CPC H04N 25/683; H04N 25/48; H04N 17/002; H04N 23/843

(57) ABSTRACT

An image processing device according to the present disclosure includes: a defect candidate pixel detecting unit that detects a defect candidate pixel for each of captured images captured in a state where positional relationships between an imaging range and an image sensor including a plurality of pixels are caused to be different from each other by performing defect candidate pixel detecting processing on each of the plurality of captured images; and an interpolation target defective pixel determining unit that determines, as an interpolation target defective pixel, a pixel detected as the defect candidate pixel a number of times greater than or equal to a threshold value by the defect candidate pixel detecting unit.

### FIELD

The present invention relates to an image processing device, an image processing method, and an image processing program.

### BACKGROUND

There is known technology of interpolating data at a pixel position that is insufficient or technology of correcting a defective pixel in each of a plurality of frame images captured using a shift imaging mode (for example, Patent Literature 1).

### CITATION LIST

### Patent Literature

Patent Literature 1: JP 2007-28008 A

### SUMMARY

### Technical Problem

According to the conventional technology, processing of interpolating a defective pixel in each image is performed before combining a plurality of images.

However, in the conventional technology, in detection-type defect correction in which a defective pixel is detected and then the pixel determined as the defective pixel is corrected, processing on the defective pixel performed before combining a plurality of images is not always appropriate. The determination may be different in each of the plurality of images, specifically, for example, a certain pixel is detected or not detected as a defective pixel. In such a case, the quality of an image (composite image) generated by composition may be adversely affected. Therefore, it is desired to appropriately determine a defective pixel.

Therefore, the present disclosure proposes an image processing device, an image processing method, and an image processing program capable of preventing deterioration in the quality of an image obtained in a pixel-shifted high-image-quality imaging mode by appropriately determining a defective pixel.

### Solution to Problem

According to the present disclosure, an image processing device includes a defect candidate pixel detecting unit that detects a defect candidate pixel for each of captured images captured in a state where positional relationships between an imaging range and an image sensor comprising a plurality of pixels are caused to be different from each other by performing defect candidate pixel detecting processing on each of the plurality of captured images; and an interpolation target defective pixel determining unit that determines, as an interpolation target defective pixel, a pixel detected as the defect candidate pixel a number of times greater than or equal to a threshold value by the defect candidate pixel detecting unit.

### BRIEF DESCRIPTION OF DRAWINGS

FIG. 1 is a diagram illustrating an example of image processing according to an embodiment of the present disclosure.

FIG. 2 is an explanatory diagram of devices used in the embodiment of the present disclosure.

FIG. 3 is a block diagram illustrating an imaging device according to the embodiment of the present disclosure.

FIG. 4 is a detailed block diagram of a detection-type defect correcting circuit.

FIG. 5 is a block diagram of an image processing device.

FIG. 6 is a block diagram of an imaging device.

FIG. 7 is a flowchart illustrating a processing procedure of an image processing system.

FIG. 8 is a sequence diagram illustrating a processing procedure of the image processing system.

FIG. 9 is a diagram illustrating an example of a processing overview by the image processing system.

FIG. 10 is a diagram illustrating an example of a processing overview by the image processing system.

FIG. 11 is a diagram illustrating an example of a processing overview by the image processing system.

FIG. 12 is a diagram illustrating an example of a processing overview by the image processing system.

FIG. 13 is a diagram illustrating an example of a processing overview by the image processing system.

FIG. 14 is a diagram illustrating an example of a processing overview by the image processing system.

FIG. 15 is a diagram illustrating an example of a processing overview by the image processing system.

FIG. 16 is a diagram illustrating an example of a Bayer arrangement.

FIG. 17 is a diagram for explaining processing of a third exemplary procedure (a).

FIG. 18 is a diagram for explaining processing of the third exemplary procedure (a).

FIG. 19 is a diagram for explaining processing of the third exemplary procedure (a).

FIG. 20 is a diagram for explaining processing of the third exemplary procedure (a).

FIG. 21 is a diagram for explaining processing of the third exemplary procedure (a).

FIG. 22 is a diagram for explaining processing of the third exemplary procedure (a).

FIG. 23 is a diagram for explaining processing of a third exemplary procedure (b).

FIG. 24 is a diagram for explaining processing of the third exemplary procedure (b).

FIG. 25A is a graph illustrating an example of the relationship between pixels and detection-type defect correction.

FIG. 25B is a graph illustrating an example of the relationship between pixels and the detection-type defect correction.

FIG. 25C is a graph illustrating an example of the relationship between pixels and the detection-type defect correction.

FIG. 26A is a graph illustrating another example of the relationship between pixels and the detection-type defect correction.

FIG. 26B is a graph illustrating another example of the relationship between pixels and the detection-type defect correction.

FIG. 26C is a graph illustrating another example of the relationship between pixels and the detection-type defect correction.

FIG. 27 is an explanatory diagram for explaining an example of a pixel-shifted image-quality-improved imaging mode.

FIG. 28 is a diagram illustrating an example of a side effect of the detection-type defect correction.

FIG. 29 is an enlarged view illustrating the example of the side effect of the detection-type defect correction.

FIG. 30A is a diagram illustrating an example of a simulation in a case where the detection-type defect correction is not performed.

FIG. 30B is a diagram illustrating an example of a simulation in a case where the detection-type defect correction is performed.

FIG. 31 is a hardware configuration diagram illustrating an example of a computer that implements the functions of the image processing device.

### DESCRIPTION OF EMBODIMENTS

Hereinafter, embodiments of the present disclosure will be described in detail on the basis of the drawings. Note that an image processing device, an image processing method, and an image processing program according to the present application are not limited by the embodiments. Note that in each of the following embodiments, the same parts are denoted by the same symbols, and redundant description will be omitted.

The present disclosure will be described in the following order of items.

1. Embodiments

1-1. Overview

1-1-1. Pixel-Shifted High-Image-Quality Imaging Mode

1-1-2. Defect Correction

1-1-3. Exemplary Procedure of Pixel-Shifted High-Image-Quality Imaging Mode

1-1-4. Comparative Technology and Problems Thereof

1-2. Overview of Image Processing According to Embodiment of Present Disclosure 1-2-1. Processing Overview

1-2-2. Specific Examples of Processing

1-2-3. Other Variations

1-3. Configuration of Devices Applicable as Image Processing Device

1-3-1. Configuration of Imaging Device

1-4. Configuration of Image Processing Device

1-5. Other Configurations of Imaging Device

1-6. Processing Procedure by Image Processing System

1-7. Processing Example by Image Processing System

1-7-1. First Processing Example

1-7-2. Second Processing Example

1-7-3. Third Processing Example

1-7-4. Fourth Processing Example

1-7-5. Fifth Processing Example

1-7-6. Sixth Processing Example

1-7-7. Seventh Processing Example

2. Other Embodiments

2-1. Others

3. Effects of Present Disclosure

4. Hardware Configuration

### 1. Embodiments

### 1-1. Overview

Prior to describing the embodiments of the present disclosure, first, an overview of the present disclosure will be described.

### 1-1-1. Pixel-Shifted High-Image-Quality Imaging Mode

There is known a pixel-shifted high-image-quality imaging method of performing a plurality of times of imaging while physically shifting an image sensor, a lens, or the like by a minute distance, combining the plurality of captured images, and generating a high-quality image.

### 1-1-2. Defect Correction

Defective pixel correction includes a method in which a position, where a defective pixel is (defective pixel address), is stored in advance and defect correction is performed on a pixel at the stored defective pixel position (hereinafter, also referred to as “address-type defect correction”) and a method in which defect correction is performed on a pixel in a case where the pixel is detected as a defective pixel (hereinafter, also referred to as “detection-type defect correction”). In the detection-type defect correction, for example, in order to correct a subsequent defective pixel that occurs due to a temporal change of an image sensor or a defective pixel that becomes apparent only at the time of long-time exposure or high temperature, whether or not a pixel is a defective pixel is estimated from values of a pixel to be processed (also referred to as a “pixel of interest”) and neighboring pixels thereof, and in a case where it is determined (detected) that the pixel is a defective pixel, the pixel is corrected. The address-type defect correction and the detection-type defect correction are often used in combination.

In the detection-type defect correction, there is a case where a pixel that receives light from sparkle that is likely to occur on a reflecting surface such as metal, a star in the nighttime sky, or the like is erroneously determined as a defect. In normal imaging of one image (frame), a side effect of erroneous detection of a defective pixel is a slight decrease in contrast or slight coloring; however, in the pixel-shifted high-image-quality imaging, in a case where defect correction is performed or not performed on the same subject portion among a plurality of captured images (a plurality of frames), there is a possibility that the image quality is deteriorated as a result of combining these images.

### 1-1-3. Exemplary Procedure of Pixel-Shifted High-Image-Quality Imaging Mode

Here, an exemplary procedure of the pixel-shifted high-image-quality imaging mode to which the technology of the present disclosure is applied will be described. In the imaging method of the exemplary procedure, a mechanism that shifts an image sensor vertically and horizontally within a light receiving plane, for example, by 1 pixel or 0.5 pixels, is provided. As the pixel-shifted high-image-quality imaging as described above, for example, the following first to third exemplary procedures are conceivable.

The first exemplary procedure is a method of performing a shift by one pixel, in which imaging is performed a total of 2×2=4 times by shifting by “0” and “1” pixels in the horizontal direction and shifting by “0” and “1” pixels in the vertical direction, and the four captured images (RAW images) are combined. A RAW image is image data in which output of the image sensor is recorded as it is, and is, for example, an image that is output from the image sensor and is having an arrangement of color filters as they are.

In the second exemplary procedure, shifting is performed by 0.5 pixels. Imaging is performed a total of 4×4=16 times by shifting by “0”, “0.5”, “1.0”, and “1.5” pixels in the horizontal direction and shifting by “0”, “0.5”, “1.0”, and “1.5” pixels in the vertical direction, and the sixteen captured images (RAW images) are combined.

In the third exemplary procedure, imaging is performed eight times, and two types will be described below as third exemplary procedures (a) and (b). In the third exemplary procedure (a), imaging is performed a total of 4×2=8 times by shifting by “0”, “0.5”, “1.0”, and “1.5” pixels in the horizontal direction and shifting by “0” and “0.5” pixels in the vertical direction (alternatively, twice in the horizontal direction and four times in the vertical direction), and the eight captured images (RAW images) are combined. In addition, in the third exemplary procedure (b), first, similarly to the first exemplary procedure, imaging is performed a total of 2×2=4 times by shifting by “0” and “1” pixels in the horizontal direction and shifting by “0” and “1” pixels in the vertical direction, and furthermore, each of the 4 times of imaging is shifted by “0.5” pixels obliquely to perform imaging 4 times, which results in a total of 8 times of imaging, and the eight captured images (RAW images) are combined.

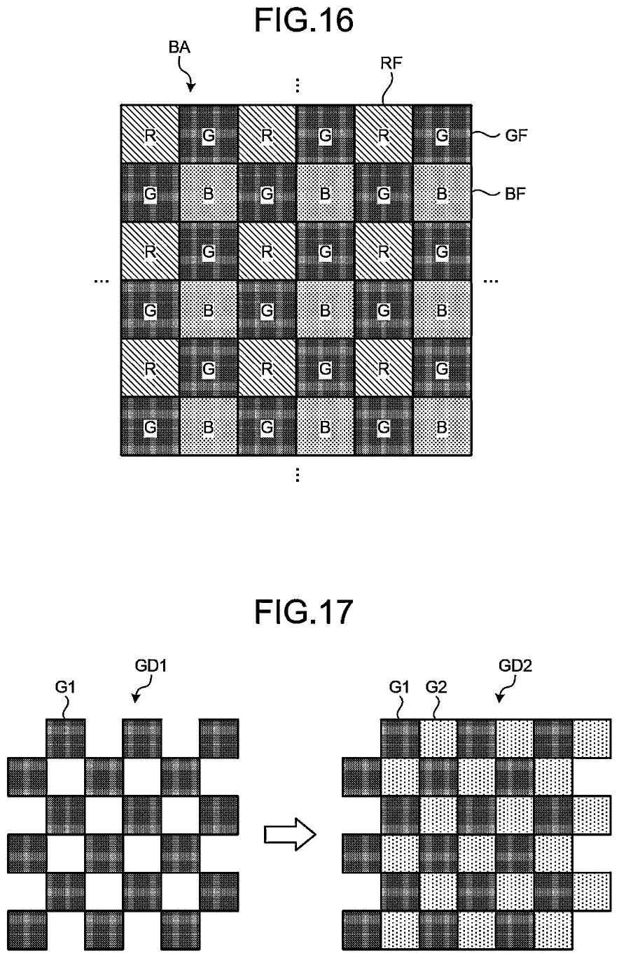

In a case where the image sensor has a Bayer arrangement as illustrated in FIG. 16, the final number of pixels of the composite image obtained in the first exemplary procedure is the same as that of the image obtained by one time of imaging without performing the composite processing, however, improvement with respect to false colors, moire, and jaggies and improvement in resolution of color signals and oblique resolution are expected.

FIG. 16 is a diagram illustrating an example of a Bayer arrangement. A Bayer arrangement BA illustrated in FIG. 16 is an arrangement (Bayer arrangement) of color filters used in a so-called image sensor, in which four pixels are regarded as one group and allocated with color filters of one red pixel, two green pixels, and one blue pixel and are regularly arranged. The Bayer arrangement BA includes a filter RF that is a color filter that transmits light in a red wavelength band, a filter GF that is a color filter that transmits light in a green wavelength band, and a filter BF that is a color filter that transmits light in a blue wavelength band. In FIG. 16, a filter with R in a rectangular frame corresponds to the filter RF, a filter with G in a rectangular frame corresponds to the filter GF, and a filter with B in a rectangular frame corresponds to the filter BF.

In the second exemplary procedure, the number of pixels that is 2×2=4 times the number of pixels of an image obtained by one-time imaging is obtained, the resolution is improved by about 2 times, and moire or jaggies of color luminance are reduced.

In the third exemplary procedure (a), the number of green pixels increases to four times, whereas the increase in red and blue pixels is merely twice. Therefore, although the color resolution of the third exemplary procedure (a) is not as high as that of the second exemplary procedure, image quality comparable to that of the second exemplary procedure can be expected in other respects. In the third exemplary procedure (b), the resolution in the oblique direction is not as good as that in the second exemplary procedure in both the luminance and the colors, however, a resolution comparable to that in the second exemplary procedure can be expected in the horizontal and vertical directions.

Note that, in the present specification, the first exemplary procedure is referred to as the pixel-shifted image-quality-improved imaging mode, the second and third exemplary procedures are referred to as a pixel-shifted super-resolution imaging mode, and the two modes are collectively referred to as the pixel-shifted high-image-quality imaging mode. The composite processing in the pixel-shifted image-quality-improved imaging mode of the first exemplary procedure is referred to as image-quality-improved composite processing, and the composite processing in the pixel-shifted super-resolution imaging mode of the second and third exemplary procedures is referred to as super-resolution composite processing. In addition, the image-quality-improved composite processing and the super-resolution composite processing are collectively referred to as high-image-quality composite processing. Note that methods other than the following examples are conceivable as the pixel-shifted high-image-quality imaging mode, and the application scope of the present invention is not limited to the following exemplary procedures.

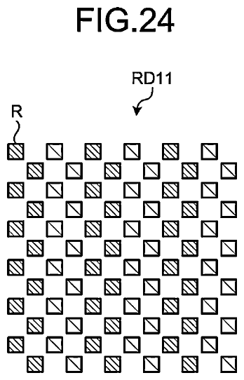

The third exemplary procedure will be described with reference to FIGS. 17 to 24. FIGS. 17 to 22 are diagrams for explaining the processing of the third exemplary procedure (a). Meanwhile, FIGS. 23 and 24 are diagrams for explaining the processing of the third exemplary procedure (b).

First, explanation will be given on green pixels illustrated in FIGS. 17 to 19. A pixel group GD1 in FIG. 17 is obtained by extracting only pixels (green pixels G1) corresponding to the filters GF in the Bayer arrangement BA in FIG. 16. Furthermore, green pixels G2 which are indicated by hatching different from that of the green pixels G1 in a pixel group GD2 in FIG. 17 indicate green pixels in a case where the image sensor is shifted rightward by one pixel from the imaging corresponding to the pixel group GD1. The green pixels G1 and the green pixels G2 complete the pixel group GD2 in which all the positions of the original pixels, except for the end points, are included.

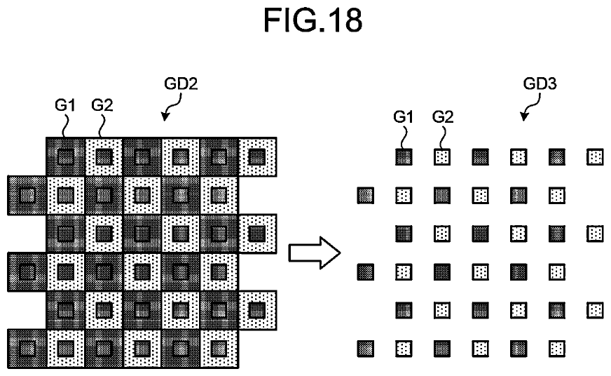

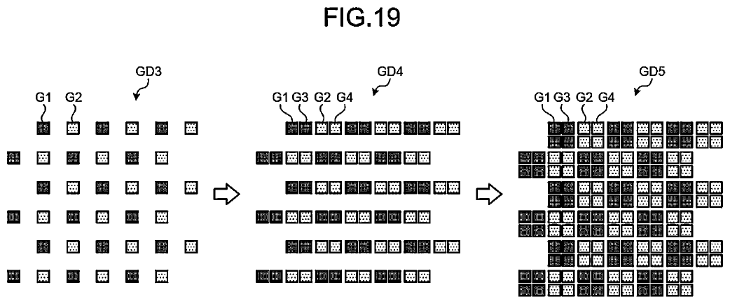

Hereinafter, for convenience of description, as illustrated in FIG. 18, the green pixels G1 and G2 in the pixel group GD2 are illustrated as small as the green pixels G1 and G2 in a pixel group GD3. A pixel group GD4 illustrated in FIG. 19 illustrates a case where third and fourth imaging are performed by shifting rightward by 0.5 pixels and 1.5 pixels, respectively, from the initial state. Green pixels G3 of the image group GD4 correspond to the third imaging and are obtained by shifting rightward by 0.5 pixels from the green pixels G1 of the first imaging, and green pixels G4 correspond to the fourth imaging and are obtained by shifting rightward by 1.5 pixels from the green pixels G1 of the first imaging. A pixel group GD5 indicates a case where fifth to eighth imaging are performed by shifting each of the first to fourth imaging downward by 0.5 pixels. As a result, the pixel group GD5 having double density of the original pixels, except for the end points, is completed.

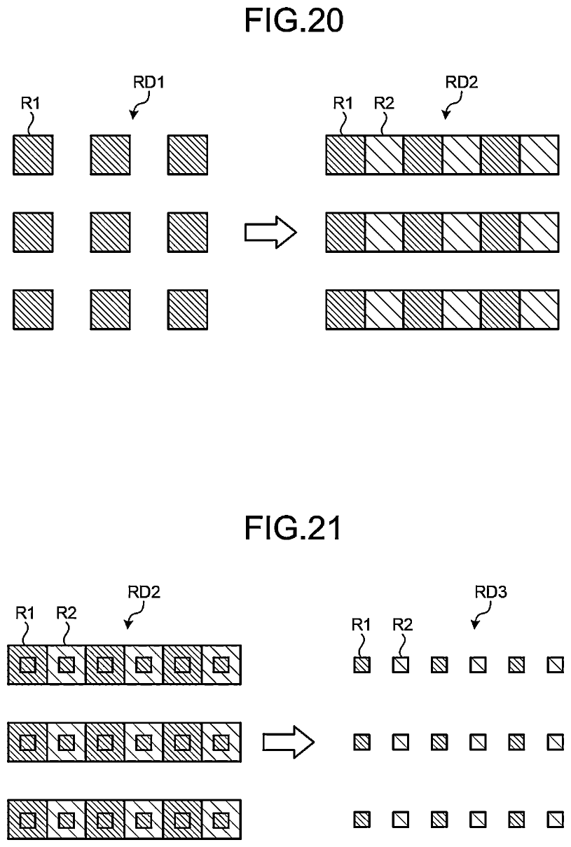

Next, red pixels illustrated in FIGS. 20 to 22 will be described. A pixel group RD1 in FIG. 20 is obtained by extracting only pixels (red pixels R1) corresponding to the filters RF in the Bayer arrangement BA in FIG. 16. Furthermore, red pixels R2 which are indicated by hatching different from that of the red pixels R1 in a pixel group RD2 in FIG. 20 indicate red pixels in a case where the image sensor is shifted rightward by one pixel from the imaging corresponding to the pixel group RD.

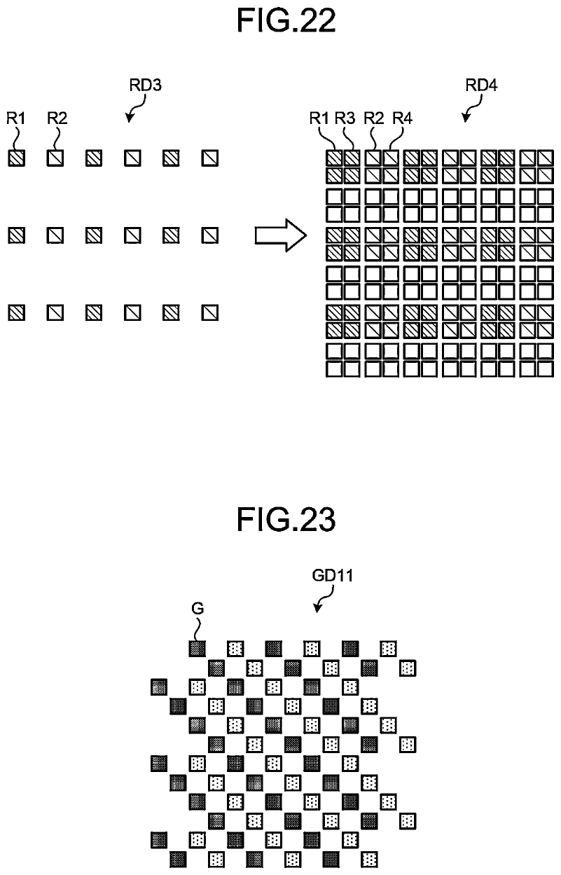

Hereinafter, for convenience of explanation, as illustrated in FIG. 21, the red pixels R1 and R2 in the pixel group RD2 are denoted as small as the red pixels R1 and R2 in a pixel group RD3. Similarly to the green image group GD5, an image group RD4 illustrates a case where the third and fourth imaging are performed by shifting rightward by 0.5 pixels and 1.5 pixels from the initial state and fifth to eighth imaging are performed by shifting each of the first to fourth imaging downward by 0.5 pixels. Hatched rectangles (such as red pixels R1 to R4) in the image group RD4 in FIG. 22 correspond to red pixels. A non-hatched rectangle in the image group RD4 indicates a position where no red pixel is imaged, and a red pixel at the position is estimated by, for example, an algorithm similar to that for demosaicing for a normal Bayer image.

With respect to blue pixels, positions of non-hatched rectangles in the image group RD4 are imaged by processing similar to that in FIGS. 20 to 22. Moreover, a hatched rectangle in the image group RD4 indicates a position where no blue pixel is imaged, and a blue pixel at the position is estimated by an algorithm similar to that of the red pixels. As described above, in the third exemplary procedure (a), it is necessary to perform processing of estimating missing information, that is, processing similar to demosaicing for a normal Bayer image, on red and blue. In the third exemplary procedure (a), rearrangement of images and processing similar to demosaicing for red and blue are included in composite processing (super-resolution composite processing).

In addition, the processing of the third exemplary procedure (b) is as illustrated in FIGS. 23 and 24. FIG. 23 illustrates a case where a pixel group GD11 is obtained by performing imaging four times by shifting by one pixel vertically, by one pixel horizontally (for example, rightward), and by one pixel obliquely (for example, obliquely downward to the right) from the initial state and by performing four more times of imaging by shifting each of the four times of imaging by 0.5 pixels obliquely (for example, obliquely downward to the right). All the green pixels G in the pixel group GD11 are imaged twice.

A pixel group RD11 illustrated in FIG. 24 illustrates an arrangement of red pixels obtained as a result of an imaging procedure similar to that performed to obtain the green pixel group GD11 illustrated in FIG. 23. The red pixels R of the pixel group RD11 image the same positions as the green pixels G of the pixel group GD11. The blue pixels are similar to the case of the red pixels illustrated in FIG. 24. In the case of the method illustrated in FIGS. 23 and 24, values of all the RGBs are obtained at checkered positions having twice the number of pixels.

Furthermore, in the case of the method illustrated in FIGS. 23 and 24, it is necessary to perform pixel interpolation processing for ensuring that each of the RGB pixels in a checkered pattern is not missing. This pixel interpolation processing is similar to the processing of interpolating green for demosaicing from a normal Bayer image.

### 1-1-4. Comparative Technology and Problems Thereof

In the present specification, technology in which detection-type defect correction is independently applied to a plurality of images obtained in the above-described pixel-shifted high-image-quality imaging mode is defined as comparative technology, and a problem thereof will be described here. Not limited to the case of the pixel-shifted high-image-quality imaging mode, in the detection-type defect correction, there is a possibility that a pixel that has received light from a subject having a small area and a large luminance difference from the vicinity thereof, such as glitter which is likely to occur on a reflecting surface such as metal or star light in the night sky, is erroneously determined as a defect. This is because these subjects can give excessive values with respect to values of neighboring pixels and thus have the same properties as those of defects, and it is difficult to distinguish between them.

In addition, in the case of imaging of a sheet of normal image, a side effect of erroneous detection appears as a phenomenon, in which the brightness of a bright spot is weakened or the contrast is reduced in the case of a subject with a fine pattern, and is subjectively allowable in many cases. However, in the pixel-shifted high-image-quality imaging mode, there is a case where even a subject, which gives an excessive value in a corresponding pixel in each of images before composition included in the plurality of images, does not necessarily give an excessive value even in a corresponding pixel in the composite image.

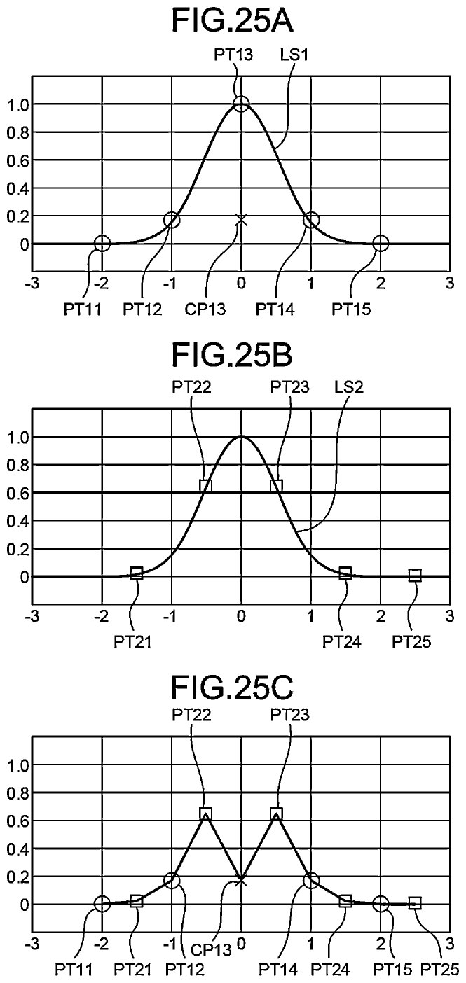

The above point will be described with reference to FIGS. 25A, 25B, and 25C. FIGS. 25A, 25B, and 25C are graphs illustrating an example of the relationship between pixels and the detection-type defect correction. Hereinafter, FIGS. 25A, 25B, and 25C may be collectively referred to as “FIG. 25”. A conceptual description will be given below with reference to FIG. 25. For example, FIG. 25 is a graph for explaining a side effect caused by detection-type defect correction specific to the pixel-shifted high-image-quality imaging mode, with the pixel-shifted super-resolution imaging mode as an example.

In FIG. 25, it is based on the premise that the image sensor is a black-and-white line sensor. A case where first imaging is performed by the image sensor, and then second imaging is performed by shifting the image sensor rightward by 0.5 pixels, and the two images obtained as a result are combined to obtain a super-resolution image will be described as an example. A line LS1 in FIG. 25A and a line LS2 in FIG. 25B are graphs illustrating the brightness in the lateral direction of a subject in which the vicinity of the center in the lateral direction is the brightest (high luminance). Note that the vertical axis is normalized by the value of the highest luminance. Furthermore, in the example of FIG. 25, in order to simplify the description, the aperture effect of the image sensor is not considered.

In the imaging (first imaging) illustrated in FIG. 25A, pixel values PT11, PT12, PT13, PT14, and PT15 indicated by circles “o” are obtained as output of five pixels of the image sensor. In the imaging (second imaging) illustrated in FIG. 25B, the sampling points are shifted rightward by 0.5 pixels from the time of imaging in FIG. 25A, and as a result, pixel values PT21, PT22, PT23, PT24, and PT25 indicated by rectangles “□” are obtained.

Then, the detection-type defect correction is performed on the pixel values PT11, PT12, PT13, PT14, and PT15 in FIG. 25A and the pixel values PT21, PT22, PT23, PT24, and PT25 in FIG. 25B. As an exemplary algorithm of the detection-type defect correction, the following procedures of a detection step and an interpolation step are presumed.

First, in the detection step, in a case where polarities (plus or minus) of differences (two differences) between the pixel value of a pixel of interest and the pixel values of both adjacent pixels are the same, and the absolute values of the differences (the two differences) both exceed a threshold value (here, 0.8), the pixel of interest is detected as a defective pixel.

Then, in the interpolation step, in a case where the pixel of interest is detected as a defective pixel in the detection step, the value of the pixel of interest (defective pixel) is replaced with an average value of the pixel values on both adjacent pixels (interpolated). Hereinafter, the interpolation step may be referred to as an “interpolation step of the comparative technology.”

By performing the above processing, the pixel value PT13 in FIG. 25A is interpolated by neighboring pixels. From the observation of FIG. 25A, the pixel located at a position of 0 in the horizontal axis is detected as a defective pixel and is replaced with (interpolated by) an average value of the pixel values on both sides, and as a result, the pixel value PT13 is corrected to an interpolation value CP13 indicated by a cross “x”. Furthermore, in FIG. 25B, since there is no pixel detected as a defective pixel, the pixel values of FIG. 25B are not corrected, and the pixel values of FIG. 25B are used for subsequent processing.

FIG. 25C is a graph illustrating a result of combining captured images illustrated in FIGS. 25A and 25B. FIG. 25C is a graph of a high-resolution super-resolution image obtained by combining the captured images of the two times of imaging in FIGS. 25A and 25B and has a waveform in which as if a hole is formed at the center of the original waveform of the subject. Specifically, since the interpolation value CP13 corresponding to the pixel at the position of 0 in the horizontal axis is smaller than the pixel value PT22 corresponding to a pixel at a position of −0.5 in the horizontal axis and the pixel value PT23 corresponding to a pixel at the position of the horizontal axis 0.5, a waveform in which the position of 0 in the horizontal axis is recessed is obtained.

Therefore, in a case where the super-resolution image in FIG. 25C is developed, the quality of the image is degraded. For example, in a case where the captured image in FIG. 25A is developed as it is, it is merely that the contrast is reduced, however in the super-resolution image obtained by super-resolution composition, the image quality is deteriorated from the above-described perspective. As described above, in the pixel-shifted high-image-quality imaging mode such as the pixel-shifted super-resolution imaging mode, a side effect of detection-type defect correction may occur.

### 1-2. Overview of Image Processing According to Embodiment of Present Disclosure

Therefore, the present disclosure proposes a method of appropriately determining a defective pixel by determining the defective pixel using results of defect detection of each pixel for each image.

### 1-2-1. Overview of Processing

First, the principle of the present technology will be described while describing the processing overview of the present disclosure with reference to FIG. 25. In FIG. 25A, the highest luminance portion of the subject coincides with the pixel at the position of 0 in the horizontal axis coordinate (also referred to as “horizontal axis 0”), however in FIG. 25B in which this is shifted rightward by 0.5 pixels and the second imaging is performed, the pixel that has been at the position of 0 in the horizontal axis coordinate is shifted to the position of 0.5 and deviates from the highest luminance portion of the subject and no longer has the value of the highest luminance portion. In other words, (the absolute value of) a difference from a neighboring pixel is below the threshold value for defect detection.

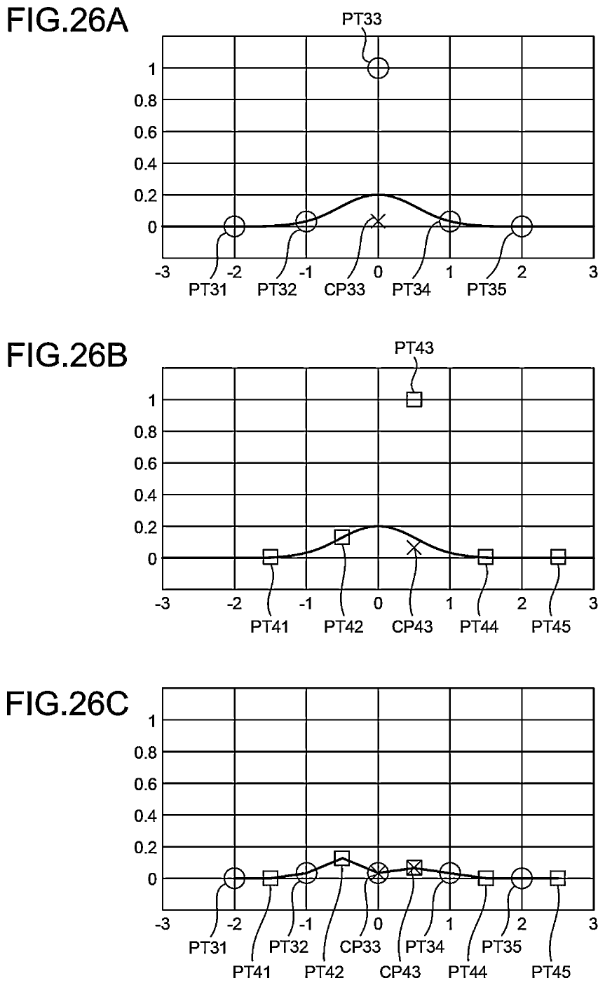

Processing in a case where there is a defective pixel will be described with reference to FIGS. 26A, 26B, and 26C. FIGS. 26A, 26B, and 26C are graphs illustrating another example of the relationship between pixels and the detection-type defect correction. Hereinafter, FIGS. 26A, 26B, and 26C may be collectively referred to as “FIG. 26”. A conceptual description will be given below with reference to FIG. 26. Note that, in FIG. 26, description of points similar to those in FIG. 25 will be omitted as appropriate.

In the imaging (first imaging) illustrated in FIG. 26A, pixel values PT31, PT32, PT33, PT34, and PT35 indicated by circles “o” are obtained as output of five pixels of the image sensor. It is based on the premise that the pixel at the position of 0 in the horizontal axis coordinate is a defect. In the imaging (second imaging) illustrated in FIG. 26B, the sampling points are shifted rightward by 0.5 pixels from the time of imaging in FIG. 26A, and as a result, pixel values PT41, PT42, PT43, PT44, and PT45 indicated by rectangles “□” are obtained.

Then, similarly to FIG. 25, by the interpolation step of the comparative technology, the detection-type defect correction is performed on the pixel values PT31, PT32, PT33, PT34, and PT35 in FIG. 26A and the pixel values PT41, PT42, PT43, PT44, and PT45 in FIG. 26B.

The pixel value PT33 in FIG. 26A is interpolated by neighboring pixels. From the observation of FIG. 26A, the pixel located at a position of 0 in the horizontal axis is detected as a defective pixel and is replaced with (interpolated by) an average value of the pixel values on both sides, and as a result, the pixel value PT33 is corrected to an interpolation value CP33 indicated by a cross “x”. Furthermore, a pixel value PT43 in FIG. 26B is interpolated by neighboring pixels. From the observation of FIG. 26B, the pixel located at the position of 0 in the horizontal axis is detected as a defective pixel and is replaced with (interpolated by) an average value of the pixel values on both sides, and as a result, the pixel value PT43 is corrected to an interpolation value CP43 indicated by a cross “x”. FIG. 26C is a graph illustrating a result of combining the captured images illustrated in FIGS. 26A and 26B. FIG. 26C is a graph of a high-resolution super-resolution image obtained by combining the captured images of the two times of imaging in FIGS. 26A and 26B and has a waveform in which the pixel value of the defective pixel is corrected. As illustrated in FIG. 26, in a case where the pixel at the position of 0 in the horizontal axis is a defective pixel, also when the pixel is shifted rightward by 0.5 pixels and imaged for the second time, the pixel is determined to be a defective pixel. The present disclosure eliminates the side effect of the above-described detection-type defect correction by determining a defective pixel using the difference between these two cases.

### 1-2-2. Specific Example of Processing

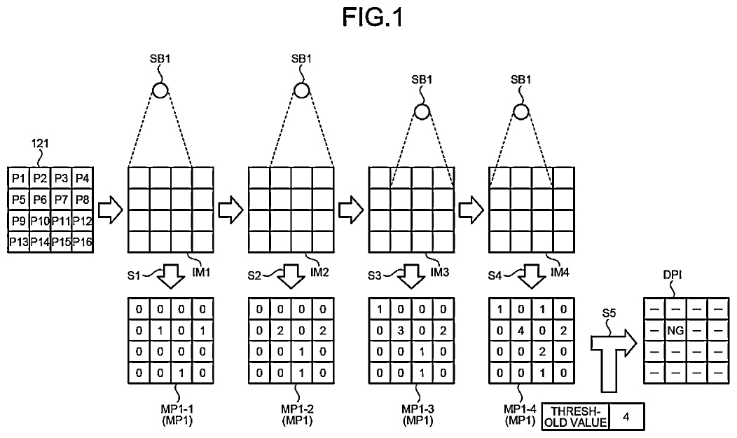

The principle of processing of determining a defective pixel will be described hereinafter with reference to FIG. 1. In FIG. 1, only sixteen pixels of pixels P1 to P16 are illustrated as an example in order to simplify the description.

In FIG. 1, the concept of shifting of the position of a subject SB1 in the plane (light-receiving plane) of an image sensor 121 in the pixel-shifted high-image-quality imaging mode is illustrated. Specifically, in FIG. 1, the shift of the position of the subject SB1 in the plane (light receiving plane) of the image sensor 121 is schematically indicated by the positional relationship between the subject SB1 and each of captured images IM1 to IM4 and dotted lines between the subject SB1 and each of the captured images IM1 to IM4.

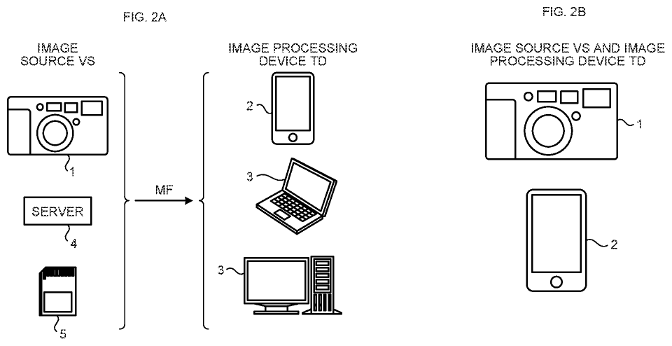

In FIG. 1, first, an image processing device TD (see FIG. 2) performs defect candidate pixel detecting processing on each pixel of the captured image IM1 obtained by performing imaging in an imaging range in which the position of the subject SB1 in the plane (light receiving plane) of the image sensor 121 is at a first position (step S1). As a simple example of an algorithm of the defect candidate pixel detecting processing, processing similar to that of the detection step described above may be used. That is, in a case where the polarities (plus or minus) of differences between a pixel to be subjected to the defect candidate pixel detecting processing (pixel of interest) and each pixel on both sides of the pixel of interest are the same, and the absolute values of the differences both exceed the threshold value (such as 0.6 or 0.75), the pixel of interest is detected as a defect candidate pixel. Note that the term “both sides” as used herein is only required to be at least one of both sides in the vertical (up-down) direction, both sides in the horizontal (right-left) direction, or both sides in an oblique (upper right, lower right, upper left, lower left) direction, and all of the above may be included, for example. Note that any algorithm may be used in the defect candidate pixel detecting processing as long as a defect candidate pixel is detected on the basis of a comparison between the value of the pixel of interest and values of neighboring pixels of the pixel of interest. The neighboring pixels mentioned here are, for example, pixels around the pixel of interest and may be adjacent to the pixel of interest or may not be adjacent to the pixel of interest.

In FIG. 1, in the captured image IM1, pixels corresponding to respective pixels P6, P8, and P15 of the image sensor 121 are detected as defect candidate pixels. As a result, as illustrated in the defect candidate pixel detection map MP1-1, “1” is added to count values at addresses corresponding to the respective pixels P6, P8, and P15 of the image sensor 121, and the count values of the pixels P6, P8, and P15 each become “1”. Note that the description is given by referring to as defect candidate pixel detection maps MP1-1 to MP1-4 depending on changes in the count value, however, the defect candidate pixel detection maps are referred to as the defect candidate pixel detection map MP1 when no distinction is made in the description.

Next, the image processing device TD performs the defect candidate pixel detecting processing on each pixel of a captured image IM2 obtained by shifting the position of the subject SB1 in the plane (light receiving plane) of the image sensor 121 from the first position to a second position and performing imaging with a different imaging range (step S2). In FIG. 1, pixels corresponding to the respective pixels P6, P8, and P11 of the image sensor 121 are detected as defect candidate pixels. As a result, as illustrated in the defect candidate pixel detection map MP1-2, “1” is added to the addresses corresponding to the respective pixels P6, P8, and P11 of the image sensor 121, the count values of the pixels P6 and P8 become “2”, and the count values of the pixels P11 and P15 become “1”.

Next, the image processing device TD performs the defect candidate pixel detecting processing on each pixel of a captured image IM3 obtained by shifting the position of the subject SB1 in the plane (light receiving plane) of the image sensor 121 from the second position to a third position and performing imaging with a different imaging range (step S3). In FIG. 1, pixels corresponding to the respective pixels P1 and P6 of the image sensor 121 are detected as defect candidate pixels. As a result, as illustrated in the defect candidate pixel detection map MP1-3, “1” is added to the addresses corresponding to the respective pixels P1 and P6 of the image sensor 121, thereby making the count values “3”, the count value of the pixel P8 becomes “2”, and the count values of the pixels P1, P11, and P15 become “1”.

Next, the image processing device TD performs the defect candidate pixel detecting processing on each pixel of a captured image IM4 obtained by shifting the position of the subject SB1 in the plane (light receiving plane) of the image sensor 121 from the third position to a fourth position and performing imaging with a different imaging range (step S4). In FIG. 1, pixels corresponding to the respective pixels P3, P6, and P11 of the image sensor 121 are detected as defect candidate pixels. As a result, as illustrated in the defect candidate pixel detection map MP1-4, “1” is added to the addresses corresponding to the respective pixels P3, P6, and P11 of the image sensor 121, thereby making the count value of the pixel P6 “4”, the count values of the pixels P8 and P11 becomes “2”, and the count values of the pixels P1, P3, and P15 become “1”.

Then, the image processing device TD determines a defective pixel using the defect candidate pixel detection map MP1-4 (step S5). In the example of FIG. 1, each of the count values in the defect candidate pixel detection map MP1-4 is compared with a threshold value “4”, and a pixel of which count value in the defect candidate pixel detection map MP1-4 is “4” is determined as an interpolation target defective pixel. In the example of FIG. 1, as indicated in interpolation target defective pixel information DPI, the pixel P6 whose count value is “4” is determined as the interpolation target defective pixel.

Then, the image processing device TD interpolates each pixel in the captured images IM1 to IM4 corresponding to the pixel P6 that has been determined as the interpolation target defective pixel with neighboring pixels and performs the defective pixel interpolating processing on the interpolation target defective pixel with neighboring pixels for the captured image including the interpolation target defective pixel. For example, in a case where the image sensor 121 is a color image sensor using color filters of the Bayer arrangement and the pixel P6 is a green pixel, the image processing device TD replaces the pixel value of the pixel P6 with an average value of pixel values of the nearest green pixels P1, P3, P9, and P11. For example, the image processing device TD interpolates the pixel P6 of the captured image IM1 by using, as neighboring pixels for interpolation, the pixels P1, P3, P9, and P11 included in the same captured image IM1 as the captured image IM1 of the pixel P6 which is the interpolation target defective pixel. The image processing device TD performs the processing of interpolating the pixel P6 similarly for the captured images IM2 to IM4. Then, the image processing device TD generates a composite image by combining the captured images IM1 to IM4 after the defective pixel interpolating processing.

As described above, the number of times each pixel is detected as a defect candidate pixel is counted, and a pixel whose number of times reaches a threshold value is determined as an interpolation target defective pixel. As a result, it is possible to appropriately determine the interpolation target defective pixel.

Moreover, the defective pixel interpolating processing is enabled for the pixel determined as the interpolation target defective pixel. As a result, the pixel that is the actual defect can be regarded as the interpolation target defective pixel and appropriately subjected to the detection-type defect correction.

If a pixel of interest is actually a defective pixel, the pixel of interest is detected as an interpolation target defective pixel in the number of images, the number larger than or equal to a threshold value, among images used for the composition, and thus the count value matches the number of captured images used for the composition. On the other hand, even if there is an image in which a pixel that is not a defect is erroneously detected as a defect candidate pixel depending on the pattern, it is unlikely that the pixel is erroneously detected as a defect candidate pixel in all images. Therefore, by determining a pixel detected as a defect candidate pixel in all images used for composition as an interpolation target defective pixel and enabling only defective pixel interpolating processing in the interpolation target defective pixel, it becomes possible to obtain good image quality without side effects due to erroneous detection.

### 1-2-3. Other Variations

In the above description, the determination criterion (threshold value) for an interpolation target defective pixel is the number of all captured images to be combined (N, 4 in FIG. 1), however, this may be modified. For example, a threshold value may be used in consideration of a case where even an actual defective pixel is not determined as an interpolation target defective pixel due to noise or the like. That is, a value less than the number of captured images may be used as a threshold value, and a pixel detected as a defect candidate pixel the number of times greater than or equal to the threshold value may be determined as an interpolation target defective pixel. For example, in the case that the number of captured images is sixteen, a value “14” that is less than sixteen may be used as a threshold value, and a pixel detected as a defect candidate pixel the number of times greater than or equal to the threshold value may be determined as an interpolation target defective pixel. In a case where the total number of images is, for example, sixteen, the image processing device TD may determine a defective pixel using, for example, 80% of the total number of images, that is, 12.8 or 13 obtained by rounding 12.8. For example, in a case where an input image has a lot of noise and the reliability of defect determination is low, it is possible to enhance the effect of overall image quality improvement by slightly lowering the threshold value and making it easier to determine as a defect. Moreover, in the case where a threshold value is less than the number of captured images, a composite image may be generated by performing the composite processing using, as a composition target image, for a captured image determined to include an interpolation target defective pixel among a plurality of captured images, the captured image subjected interpolation of the interpolation target defective pixel, and for an image determined not to include an interpolation target defective pixel, using a captured image not subjected to interpolation as a composition target image.

The image sensor 121 may be either a black-and-white sensor (monochrome sensor) or a color image sensor. Hereinafter, side effects due to the detection-type defect correction in a case where a color captured image is a target, that is, in a case where the image sensor 121 is a color image sensor will be specifically described. For example, in a color image sensor using color filters of the Bayer arrangement, green pixels are densely arranged, and red and blue pixels are more sparsely arranged than green pixels. Therefore, in the detection-type defect correction, a defect is detected by referring to pixels farther for red and blue than for green.

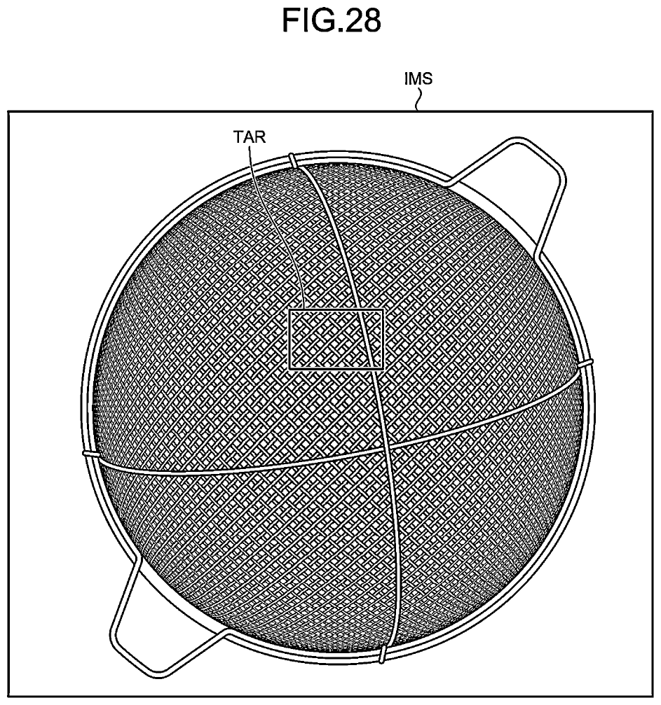

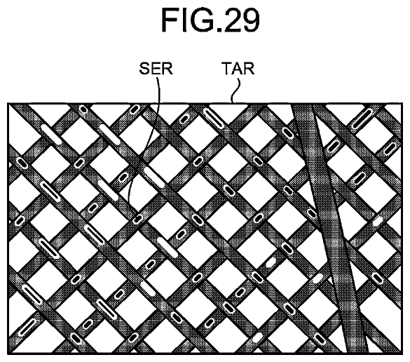

Therefore, the rate at which a high-luminance subject having a small area and a large luminance difference from the vicinity is erroneously recognized as a defect is higher for the red and blue pixels than for the green pixels. Therefore, in a case as illustrated in FIG. 25, a situation is likely to occur in which the detection-type defect correction is performed on red and blue pixels in the vicinity of the maximum luminance portion and the detection-type defect correction is not performed on green pixels. As described above, in the case of a color image sensor, since sample intervals are longer for red and blue than for green, erroneous correction occurs with a higher probability than green. As a result, values for red and blue are subjected to the defective pixel interpolating processing with pixel values of neighboring pixels and decrease, whereas values for green do not decrease, and a bright spot as the high luminance portion may turn green. As a result, the composite image is likely to include a green scratch in the vicinity of the center of the high luminance portion. FIGS. 28 and 29 are schematic diagrams illustrating an actual example of the above. FIG. 28 is a diagram illustrating an example of a side effect of the detection-type defect correction. FIG. 29 is an enlarged view illustrating the example of the side effect of the detection-type defect correction. FIG. 28 is an example of the composite image in which the side effect has occurred, and FIG. 29 is an enlarged view of a part of the example of the composite image in which the side effect has occurred.

A composite image example IMS illustrated in FIG. 28 illustrates an exemplary case where an image has a green flaw in a metal object. FIG. 29 is an enlarged schematic view of a portion of a region TAR in the image example IMS of FIG. 28, and portions like a green scratch SER are generated in the vicinity of the center of a bright portion. Note that, in FIG. 29, for convenience of color expression, a metal object is illustrated in gray, regions of reflecting surfaces that are sparkly bright in the metal object are illustrated in white, and portions that are green in the regions of the reflecting surfaces are illustrated in black. In this manner, in the example of FIG. 29, the composite image looks like as if green scratches are included in the vicinity of the center of the portions that are brightly reflecting.

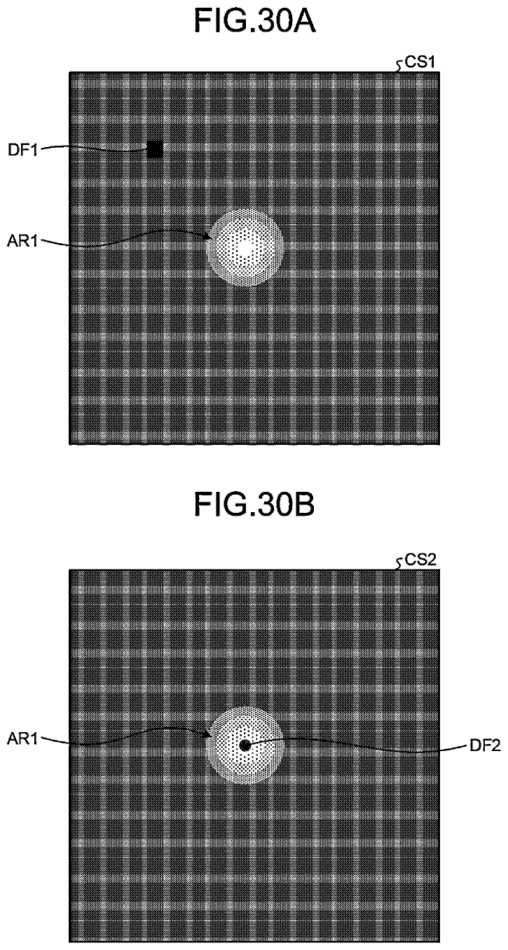

An example of simulation of side effects will be described with FIGS. 30A and 30B. FIG. 30A is a diagram illustrating an example of a simulation in a case where the detection-type defect correction is not performed. FIG. 30B is a diagram illustrating an example of a simulation in a case where the detection-type defect correction is performed. Hereinafter, FIGS. 30A and 30B may be collectively referred to as “FIG. 29”. A conceptual description will be given below with reference to FIG. 29. Illustrated in FIG. 29 is a simulation result in a case where the detection-type defect correction is applied to each captured image before composition using the above-described comparative technology in imaging a subject having a small area and being much brighter than its vicinity in the pixel-shifted super-resolution imaging mode.

FIG. 30A is a diagram illustrating a simulation result CS1 in which a defective pixel portion DF1 having a size of 4×4 pixels appears at the upper left in a case where the detection-type defect correction is turned off. In this manner, FIG. 30A illustrates that the green pixel at the upper left of the screen is a defective pixel portion, and in a case where the detection-type defect correction is not performed, the defective pixel portion DF1 at the upper left of the screen remains as a defect as it is at the same position in the composite image.

FIG. 30B is a diagram illustrating a simulation result CS2 in which the influence of the defective pixel portion DF1 disappears, but a green flaw (point DF2) occurs in a central portion AR1 of the subject in a case where the detection-type defect correction is turned on. For example, as in FIG. 30A, FIG. 30B illustrates a case where the detection-type defect correction is performed on an image including the defective pixel portion DF1 having a size of 4×4 on the upper left. As described above, in FIG. 29, the defective pixel portion DF1 is corrected by the detection-type defect correction, however, the green point DF2 is formed in the portion AR1 having the highest luminance.

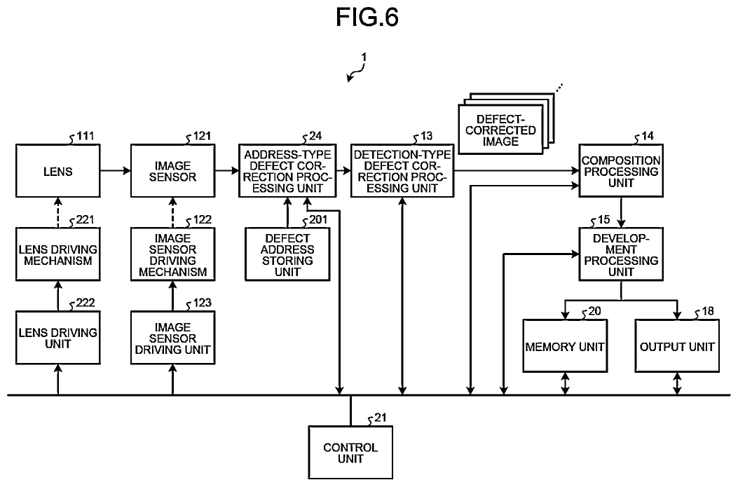

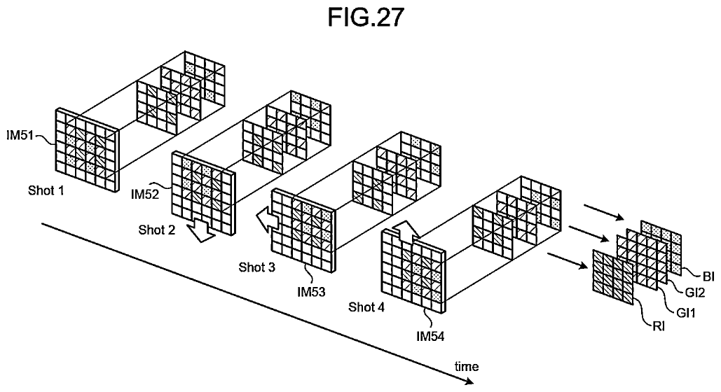

In the present technology, the number of times each pixel of each captured image is detected as a defect is counted. For example, using the image sensor 121 (see FIG. 6) using the color filters of the Bayer arrangement BA as illustrated in FIG. 16, a plurality of color images is captured in the pixel-shifted image-quality-improved imaging mode which is one of the pixel-shifted high-image-quality imaging modes as illustrated in FIG. 27. FIG. 27 is an explanatory diagram for explaining an example of the pixel-shifted image-quality-improved imaging mode. Note that the Bayer arrangement BA illustrated in FIG. 16 is merely an example, and a color image may be captured using color filters of various arrangements without being limited to the Bayer arrangement.

Using the image sensor 121 to which the Bayer arrangement BA illustrated in FIG. 16 is applied, a plurality of color images is captured in the above-described pixel-shifted high-image-quality imaging mode. FIG. 27 is a diagram conceptually illustrating processing of the pixel-shifted high-image-quality imaging mode using the image sensor 121 to which the Bayer arrangement BA illustrated in FIG. 16 is applied. In FIG. 27, a plurality of captured images is captured by shifting the image sensor 121 by one pixel in the vertical direction. In this manner, by performing a plurality of times of imaging by matching a range of a subject (imaging range) corresponding to one pixel with each of pixel positions of red, green, and blue, a composite image is generated by directly combining a plurality of captured images without performing demosaic (color separation) processing. For example, by sequentially shifting the image sensor 121 by one pixel and continuously shooting, a plurality of captured images IM51 to IM54 (corresponding to Shot 1 to Shot 4 in FIG. 27) is acquired.

The image processing device TD performs defect detection processing on each of the plurality of captured images. In the example of FIG. 27, the image processing device TD performs the defect candidate pixel detecting processing on each of the four captured images of the captured image IM51 of Shot 1, the captured image IM52 of Shot 2, the captured image IM53 of Shot 3, and the captured image IM54 of Shot 4. Note that, in a color image, it is desirable to perform the defect candidate pixel detecting processing by referring to pixels of the same color.

For example, in a case where the polarities (plus or minus) of differences between a pixel to be subjected to the defect candidate pixel detecting processing (pixel of interest) and neighboring pixels having the same color as that of the pixel of interest, and the absolute values of the differences both exceed the threshold value (such as 0.6 or 0.75), the image processing device TD (see FIG. 2) des the pixel of interest as a defect candidate pixel. For example, the image processing device TD may use four pixels above, below, on the left, and on the right of the pixel of interest as neighboring pixels or may use eight pixels above, below, on the left, on the right, and in the oblique directions of the pixel of interest as neighboring pixels. Furthermore, the image processing device TD may set pixels in a 5×5 region centered on the pixel of interest or pixels in a 7×7 region centered on the pixel of interest as neighboring pixels. For example, the image processing device TD may detect the pixel of interest as a defect candidate pixel using statistics of the pixels in the 5×5 or 7×7 region centered on the pixel of interest. For example, in a case where the distance between the pixel of interest and each of the upper right pixel and the lower left pixel among pixels having the same color as that of the pixel of interest is shorter than that from other pixels, the image processing device TD may perform the defect candidate pixel detecting processing on the pixel of interest by using the upper right pixel and the lower left pixel as neighboring pixels. The image processing device TD counts the number of times each pixel is detected as a defect candidate pixel by performing the defect candidate pixel detecting processing on each pixel of each of the captured images.

Then, a pixel whose number of times of detection as a defect candidate pixel has reached the number of the plurality of captured images (for example, N) is determined as an interpolation target defective pixel. As a result, it is possible to appropriately determine the interpolation target defective pixel also for a color image.

In addition, the image processing device TD performs the defective pixel interpolating processing using neighboring pixels only for a pixel determined as an interpolation target defective pixel. As a result, similarly to the black-and-white image, the image processing device TD can appropriately perform the detection-type defect correction processing targeted on an interpolation target defective pixel, which is an actual defective pixel, also for a color image. The image processing device TD generates an image of each color for which the defective pixel interpolating processing using neighboring pixels has been performed only for a pixel determined as an interpolation target defective pixel and generates a composite image by the high-image-quality composite processing in which images corresponding to every color, for which the defective pixel interpolating processing has been performed, are combined only for the pixel determined as the interpolation target defective pixel. In the example of FIG. 27, the image processing device TD generates four images of one red image RI, two green images GI1 and GI2, and one blue image BI by the defective pixel interpolating processing and generates a composite image by the high-image-quality composite processing of combining the red image RI, the green images GI1 and GI2, and the blue image BI. For example, the image processing device TD performs high-image-quality composite processing of rearranging the four images into four planes of the green images GI1 and GI2, the red image RI, and the blue image BI, averaging the two green images GI1 and GI2 to generate a green image GI to obtain three planes of the red image RI, the green image GI, and the image BI. Note that, in the second exemplary procedure of the pixel-shifted high-image-quality imaging mode in which imaging is performed sixteen times, the green images GI1 and GI2, the red image RI, and the blue image BI in which the number of pixels is increased by 4 times as a result of the rearrangement are obtained, and the high-image-quality composite processing is performed in which, similarly, a green image GI is generated by averaging the two green images Gil and GI2 to obtain three planes of the red image RI, the green image GI, and the image BI.

### 1-3. Configuration of Device Applicable as Image Processing Device

The image processing device that performs the above processing can be implemented in various devices. First, devices to which the technology of the present disclosure can be applied will be described with reference to FIG. 2. FIG. 2 is an explanatory diagram of devices used in the embodiment of the present disclosure.

Illustrated in FIG. 2A are examples of an image source VS and the image processing device TD that acquires an image file MF from the image source VS. The image processing device TD performs image processing on image data acquired from the image source VS. The image processing herein includes at least one of the defect candidate pixel detecting processing of detecting a defect candidate pixel for each captured image, the interpolation target defective pixel determining processing of determining an interpolation target defective pixel from defect candidate pixels, and the defective pixel interpolating processing of interpolating an interpolation target defective pixel. Note that the “interpolation target defective pixel determining processing” may be referred to as “defect erroneous detection determining processing”.

As the image source VS, an imaging device 1, a server 4, a recording medium 5, and the like are presumed. As the image processing device TD, a mobile terminal 2 such as a smartphone, a personal computer 3, or the like are presumed. In addition, as the image processing device TD, various devices such as an image editing dedicated device, a cloud server, a television device, and a video recording and reproducing device are presumed as the image processing device TD.

The imaging device 1 as the image source VS is a digital camera or the like and transfers an image file MF obtained by imaging to the mobile terminal 2, the personal computer 3, or the like via wired communication or wireless communication. The server 4 may be any one of a local server, a network server, a cloud server, or the like and refers to a device capable of providing the image file MF captured by the imaging device 1. The server 4 transfers the image file MF to the mobile terminal 2, the personal computer 3, or the like via some transmission path.

The recording medium 5 may be any of a solid-state memory such as a memory card, a disc-shaped recording medium such as an optical disc, a tape-shaped recording medium such as a magnetic tape, and the like, and is a removable recording medium on which the image file MF captured by the imaging device 1 is recorded. The image file MF read from the recording medium 5 is read by the mobile terminal 2, the personal computer 3, or the like.

The mobile terminal 2, the personal computer 3, or the like as the image processing device TD can perform the image processing on the image file MF acquired from the above image source VS.

Note that the mobile terminal 2 or the personal computer 3 may serve as the image source VS for another mobile terminal 2 or personal computer 3 functioning as the image processing device TD.

FIG. 2B illustrates the imaging device 1 and the mobile terminal 2 as one device that can function as both the image source VS and the image processing device TD. For example, a microcomputer or the like inside the imaging device 1 performs the image processing. For example, the imaging device 1 can output an image in which a defective pixel is interpolated by performing the defect candidate pixel detecting processing, the interpolation target defective pixel determining processing, and the defective pixel interpolating processing on the image file MF generated by imaging.

Similarly, since the mobile terminal 2 can be the image source VS by having an imaging function, the mobile terminal 2 can output an image in which a defective pixel is interpolated by performing the defect candidate pixel detecting processing, the interpolation target defective pixel determining processing, and the defective pixel interpolating processing on the image file MF generated by imaging. Note that, without being limited to the imaging device 1 or the mobile terminal 2, various other devices are also conceivable as a device that can serve both as an image source and an image processing device.

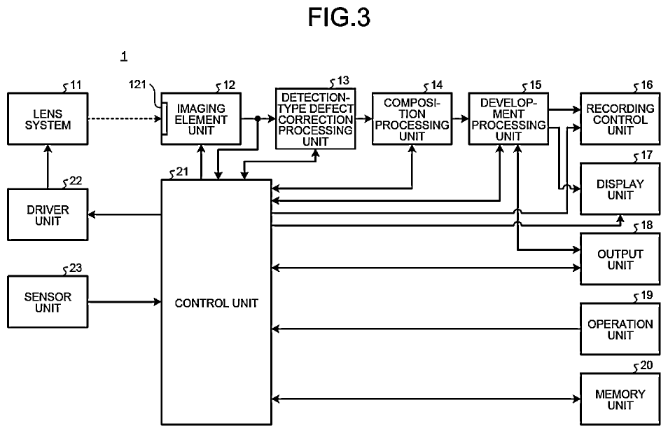

As described above, there are various devices that function as the image processing device TD and various image sources VS of the embodiment, however, in FIG. 3 below, the imaging device 1 that is both the image source VS and the image processing device TD of FIG. 2B will be described as an example.

### 1-3-1. Configuration of Imaging Device

The configuration of the imaging device 1 that is an image source VS as well as an image processing device TD in FIG. 2B will be described with reference to FIG. 3. FIG. 3 is a block diagram illustrating the imaging device according to the embodiment of the present disclosure.

The imaging device 1 in FIG. 3 includes a lens system 11, an imaging element unit 12, a detection-type defect correction processing unit 13, a composition processing unit 14, a development processing unit 15, a recording control unit 16, a display unit 17, an output unit 18, an operation unit 19, a memory unit 20, a control unit 21, a driver unit 22, and a sensor unit 23.

The lens system 11 includes lenses (for example, a lens 111 in FIG. 6) such as a cover lens, a zoom lens, and a focus lens, a diaphragm mechanism, and others. Light (incident light) from a subject is guided by the lens system 11 and condensed on the imaging element unit 12.

The imaging element unit 12 includes, for example, the image sensor 121 (imaging element) of a complementary metal oxide semiconductor (CMOS) type, a charge coupled device (CCD) type, or the like. The imaging element unit 12 executes, for example, correlated double sampling (CDS) processing, automatic gain control (AGC) processing, and the like on an electric signal obtained by photoelectrically converting the light received by the image sensor 121 and further performs analog-to-digital (A/D) conversion processing. Then, an imaging signal as digital data is output to the detection-type defect correction processing unit 13 or the control unit 21 in the subsequent stage.

The image sensor 121 may be configured so that each of a plurality of pixels detects the intensity of light and captures a monochrome image. Alternatively, as illustrated in FIG. 16, the pixels of the image sensor 121 may detect any of red, blue, and green. The pixels of the image sensor 121 may be applied with the Bayer arrangement BA in FIG. 16, and the number of pixels that correspond to the filters GF and detect green light may be larger than the number of pixels that correspond to the filters RF and detect red light or the number of pixels that correspond to the filters BF and detect blue light.

The imaging element unit 12 includes a driving unit (for example, an image sensor driving unit 123 in FIG. 6) that moves the position of the image sensor 121, and the image sensor 121 can be shifted in the horizontal direction and the vertical direction by one pixel or by one subpixel. For example, the imaging element unit 12 includes an actuator (for example, an image sensor driving mechanism 122 in FIG. 6), and a shift operation (a shift direction and a shift amount) is controlled in accordance with an instruction from the control unit 21. For example, the imaging element unit 12 can move the image sensor 121 by a predetermined unit (for example, a pitch of 0.5 pixels, a pitch of 1 pixel, or the like) in the horizontal direction and the vertical direction at least in a light receiving plane (predetermined plane) perpendicular to the optical axis so that the image sensor 121 can capture a plurality of images.

In the above example, the case where the imaging device 1 implements the pixel-shifted high-image-quality imaging mode by changing the position of the image sensor 121 has been described as an example, however, imaging may be performed by changing the position or the attitude of components other than the image sensor 121. For example, the imaging device 1 may perform imaging by changing the position or the attitude of the lens system 11 or the device itself (that is, the entire imaging device 1). For example, the imaging device 1 may change the position or the attitude of a lens of the lens system 11. Furthermore, the position or the attitude of the imaging device 1 may be modified by a driving device (a camera platform, a tripod, a stabilizer, or the like) other than the imaging device 1 or by a user.

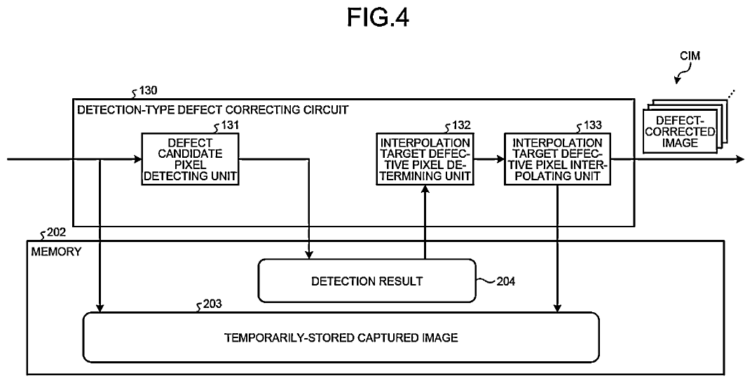

The detection-type defect correction processing unit 13 performs defect candidate pixel detecting processing, interpolation target defective pixel determining processing, defective pixel interpolating processing, and others on the captured image input from the imaging element unit 12 and passes the captured image after the interpolation processing to the composition processing unit 14. The detection-type defect correction processing unit 13 is, for example, a detection-type defect correcting circuit 130 as illustrated in FIG. 4, and details of FIG. 4 will be described later. Note that the detection-type defect correction processing unit 13 may perform processing by software.

The composition processing unit 14 performs the high-image-quality composite processing on a defect-corrected image in which a defective pixel is interpolated by the detection-type defect correction processing unit 13. The composition processing unit 14 performs the high-image-quality composite processing corresponding to the number of captured images as described above.

The development processing unit 15 performs development processing on the composite image generated by the composition processing unit 14. The development processing performed by the development processing unit 15 includes processing of converting RGB data into luminance data Y and chrominance data C of a YC system, adjustment of white balance, γ correction, and others. Note that the development processing performed by the development processing unit 15 does not include demosaic processing.

The recording control unit 16 performs recording and reproduction with respect to a recording medium by a nonvolatile memory, for example. The recording control unit 16 performs processing of recording, for example, an image file MF such as moving image data or still image data, an image after the development processing, or the like on a recording medium. Various actual forms are conceivable as the recording control unit 16. For example, the recording control unit 16 may be configured as a flash memory built in the imaging device 1 and a write and read circuit thereof or may be in a form of a card recording and reproducing unit that performs recording and reproducing access to a recording medium that can be attached to and detached from the imaging device 1 such as a memory card (portable flash memory or the like). Alternatively, the recording control unit 16 may be a hard disk drive (HDD) or the like as a form built in the imaging device 1.

The display unit 17 performs various displays for an imaging operator, and is, for example, a display panel or a viewfinder by a display device such as a liquid crystal display (LCD) or an organic electro-luminescence (EL) display arranged in a housing of the imaging device 1. The display unit 17 executes various displays on a display screen on the basis of an instruction from the control unit 21. For example, the display unit 17 displays a reproduced image of image data read from the recording medium in the recording control unit 16. Furthermore, the display unit 17 causes various operation menus, icons, messages, and the like, that is, display as a graphical user interface (GUI), to be executed on the screen on the basis of an instruction from the control unit 21.

The output unit 18 performs data communication or network communication with an external device in a wired or wireless manner. The output unit 18 transmits and outputs captured image data (still image file or moving image file) to, for example, an external display device, a recording device, a reproduction device, or the like. Furthermore, as a network communication unit, the output unit 18 may perform communication via various networks such as the Internet, a home network, and a local area network (LAN) and transmit and receive various types of data to and from a server, a terminal, or the like on the network.

The operation unit 19 collectively indicates input devices for a user to perform various types of operation input. Specifically, the operation unit 19 indicates various operators (keys, dials, touch panels, touch pads, etc.) provided in a housing of the imaging device 1. The operation of the user is detected by the operation unit 19, and a signal corresponding to the input operation is sent to the control unit 21.

The control unit 21 includes a microcomputer (arithmetic processing device) including a central processing unit (CPU). The memory unit 20 stores information and the like used for processing by the control unit 21. The memory unit 20 comprehensively indicates, for example, a read only memory (ROM), a random access memory (RAM), a flash memory, and the like. The memory unit 20 may be a memory area built in a microcomputer chip as the control unit 21 or may be configured by a separate memory chip. The control unit 21 controls the entire imaging device 1 by executing a program stored in the ROM, the flash memory, or the like of the memory unit 20. For example, the control unit 21 controls the operation of each unit as necessary with respect to control of the shutter speed of the imaging element unit 12, an instruction of various types of image processing in the detection-type defect correction processing unit 13, imaging operation or recording operation in accordance with user's operation, reproduction operation of a recorded image file, operation of the lens system 11 such as zooming, focusing, and diaphragm adjustment in a lens barrel, user interface operation, and the like.

The RAM in the memory unit 20 is used for temporary storage of data, programs, and the like as a work area at the time of various data processing of the CPU of the control unit 21. The ROM and the flash memory (nonvolatile memory) in the memory unit 20 are used for storing the operating system (OS) for the CPU to control each unit, content files such as image files, application programs for various types of operation, firmware, and others.

The driver unit 22 includes, for example, a motor driver for a zoom lens driving motor, a motor driver for a focus lens driving motor, a motor driver for a motor of a diaphragm mechanism, and the like. These motor drivers apply a drive current to a corresponding driver according to an instruction from the control unit 21 and cause the driver to execute shift of a focus lens or a zoom lens, opening or closing of diaphragm blades of the diaphragm mechanism, and the like.

The sensor unit 23 comprehensively indicates various sensors mounted on the imaging device. As the sensor unit 23, for example, an acceleration sensor, a position information sensor, an illuminance sensor, or the like may be mounted. Note that the imaging device 1 of FIG. 3 may have a configuration illustrated in FIG. 6 other than an address-type defect correction processing unit 24. The imaging device 1 in FIG. 3 may include a memory unit 20, a lens 111, a lens driving mechanism 221, a lens driving unit 222, an image sensor driving mechanism 122, and an image sensor driving unit 123.

Here, FIG. 4 will be described. FIG. 4 is a detailed block diagram of a detection-type defect correcting circuit. As illustrated in FIG. 4, a detection-type defect correcting circuit 130 includes a defect candidate pixel detecting unit 131, an interpolation target defective pixel determining unit 132, and an interpolation target defective pixel interpolating unit 133.

The defect candidate pixel detecting unit 131 performs the defect candidate pixel detecting processing on a RAW image input thereto. The input RAW image is stored in a memory 202 as a temporarily-stored captured image 203. The memory 202 may be a memory unit 20. Note that the memory 202 may be inside the detection-type defect correcting circuit 130.

A detection result 204 of the defect candidate pixel detecting processing by the defect candidate pixel detecting unit 131 is stored in the memory 202. The detection result 204 is, for example, a defect candidate pixel detection map indicating an address and a count value of a defect candidate pixel. Note that the detection result 204 is not limited to the defect candidate pixel detection map and may be a defect candidate pixel address list or the like that indicates addresses of pixels detected as defect candidate pixels. In a case where the defect candidate pixel detecting unit 131 performs counting-up, the defect candidate pixel detecting unit 131 holds the count value of each pixel and stores the detection result 204 of the defect candidate pixel detecting processing in the memory 202. In the case of grasping only addresses of defect candidate pixels, the defect candidate pixel detecting unit 131 counts up at the time of overwriting corresponding addresses of the memory 202 with the memory 202.

The imaging device 1 associates the input RAW image with a defect candidate pixel detection map that is the detection result 204 of the defect candidate pixel detecting unit. Here, the term “associate” means, for example, to allow another piece of information to be used (linked) when one piece of information (data, command, program, etc.) is processed. That is, the pieces of information associated with each other may be integrated as one file or the like or may be separate pieces of information. For example, information B associated with information A may be transmitted on a transmission path different from that of the information A. Furthermore, for example, information B associated with information A may be recorded in a recording medium different from that of the information A (or another recording area of the same recording medium). Note that this “association” may be performed on a part of information instead of the entire information. For example, an image and information corresponding to the image may be associated with each other in any unit such as a plurality of frames, one frame, or a part in a frame. More specifically, for example, actions such as assigning the same ID (identification information) to a plurality of pieces of information, recording a plurality of pieces of information in the same recording medium, storing a plurality of pieces of information in the same folder, storing a plurality of pieces of information in the same file (assigning one piece of information to another as metadata), embedding a plurality of pieces of information in the same stream, and embedding metadata in an image such as an electronic watermark are included in “associating”. The recording control unit 16, the output unit 18, or the control unit 21 in FIG. 3 functions as an association unit that performs the above-described “association” processing.

The interpolation target defective pixel determining unit 132 performs the interpolation target defective pixel determining processing. The interpolation target defective pixel determining unit 132 determines an interpolation target defective pixel using the detection result 204 stored in the memory 202. For example, the interpolation target defective pixel determining unit 132 determines a pixel whose count value is larger than or equal to a threshold value in the defect candidate pixel detection map as the detection result 204 as an interpolation target defective pixel. The interpolation target defective pixel determining unit 132 passes an interpolation target defective pixel address list indicating a pixel determined as an interpolation target defective pixel to the interpolation target defective pixel interpolating unit 133.

The interpolation target defective pixel interpolating unit 133 performs the defective pixel interpolating processing on the basis of the determination result by the interpolation target defective pixel determining unit 132. The interpolation target defective pixel interpolating unit 133 interpolates each pixel corresponding to an interpolation target defective pixel indicated by the interpolation target defective pixel address list among pixels in the temporarily-stored captured image 203 stored in the memory 202 with neighboring pixels. The interpolation target defective pixel interpolating unit 133 passes the defect-corrected image CIM generated by the defective pixel interpolating processing to the composition processing unit 14.

### 1-4. Configuration of Image Processing Device

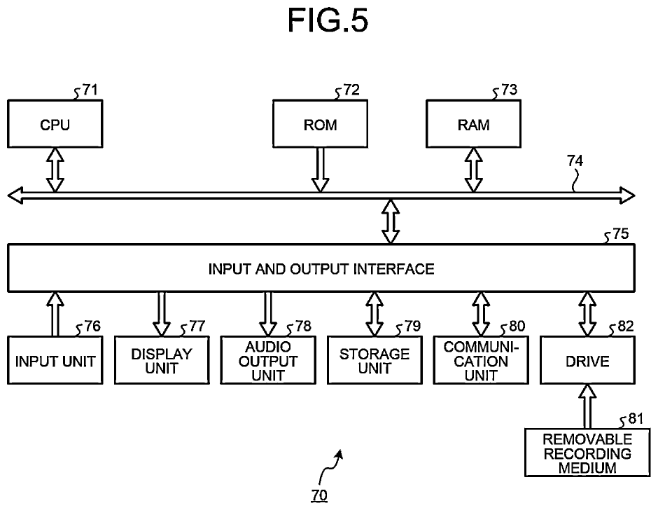

Furthermore, the image file MF can be transferred to the image processing device TD such as the mobile terminal 2 and subjected to the image processing. The mobile terminal 2 and the personal computer 3 serving as the image processing device TD can be implemented as an image processing device having the configuration illustrated in FIG. 5, for example. Note that the server 4 can also be similarly implemented by an image processing device having the configuration of FIG. 5. FIG. 5 is a block diagram of an image processing device.

In FIG. 5, a CPU 71 of an image processing device 70 executes various types of processing in accordance with a program stored in a ROM 72 or a program loaded from a storage unit 79 to a RAM 73. The RAM 73 also, as required, stores data and the like necessary for the CPU 71 to execute various types of processing. The CPU 71, the ROM 72, and the RAM 73 are connected to one another via a bus 74. An input and output interface 75 is also connected to the bus 74.

An input unit 76 including an operator or an operation device is connected to the input and output interface 75. For example, as the input unit 76, various operators or operation devices such as a keyboard, a mouse, a key, a dial, a touch panel, a touch pad, and a remote controller are conceivable. An operation by a user is detected by the input unit 76, and a signal corresponding to the input operation is interpreted by the CPU 71.

In addition, a display unit 77 including an LCD, an organic EL panel, or the like and an audio output unit 78 including a speaker or the like are integrally or separately connected to the input and output interface 75. The display unit 77 performs various displays and includes, for example, a display device included in a housing of the image processing device 70, a separate display device connected to the image processing device 70, or the like. The display unit 77 displays images and the like for various types of image processing on a display screen on the basis of an instruction from the CPU 71. In addition, the display unit 77 displays various operation menus, icons, messages, and the like, in other words, performs display as a graphical user interface (GUI) on the basis of an instruction from the CPU 71.

In some cases, the storage unit 79 including a hard disk, a solid state memory, or the like and a communication unit 80 including a modem or the like are connected to the input and output interface 75. The communication unit 80 performs communication processing via a transmission path such as the Internet or performs communication with various devices by wired or wireless communication, bus communication, or others.

A drive 82 is further connected to the input and output interface 75 as necessary, and a removable recording medium 81 such as a magnetic disk, an optical disc, a magneto-optical disc, or a semiconductor memory is mounted as required. A data file such as the image file MF, various computer programs, and the like can be read from the removable recording medium 81 by the drive 82. The read data file is stored in the storage unit 79, or images or audio included in the data file are output by the display unit 77 or the audio output unit 78. Furthermore, a computer program or the like read from the removable recording medium 81 is installed in the storage unit 79, as necessary.

In the image processing device 70, for example, software for image processing as the image processing device of the present disclosure can be installed via network communication by the communication unit 80 or the removable recording medium 81. Alternatively, the software may be stored in advance in the ROM 72, the storage unit 79, or the like.

### 1-5. Other Configurations of Imaging Device

Another example of the configuration of the imaging device 1 that is both the image source VS and the image processing device TD in FIG. 2B will be described with reference to FIG. 6. FIG. 6 is a block diagram of an imaging device. An imaging device 1 illustrated in FIG. 6 is different from the imaging device 1 illustrated in FIG. 3 in that an address-type defect correction processing unit 24 and a defect address storing unit 201. Note that description of points similar to those of the imaging device 1 illustrated in FIG. 3 will be omitted as appropriate.

The imaging device 1 in FIG. 6 includes a lens 111, a lens driving mechanism 221, a lens driving unit 222, an image sensor 121, an image sensor driving mechanism 122, an image sensor driving unit 123, an address-type defect correction processing unit 24, a defect address storing unit 201, a detection-type defect correction processing unit 13, a composition processing unit 14, a development processing unit 15, an output unit 18, a memory unit 20, and a control unit 21. For example, the lens 111 corresponds to the lens system 11 in FIG. 3, and the lens driving mechanism 221 and the lens driving unit 222 correspond to the driver unit 22 in FIG. 3. Furthermore, the image sensor 121, the image sensor driving mechanism 122, and the image sensor driving unit 123 correspond to the imaging element unit 12 in FIG. 3. Note that the imaging device 1 in FIG. 6 may include the recording control unit 16, the display unit 17, the operation unit 19, and the sensor unit 23.

The image sensor driving unit 123 shifts the image sensor 121 in the horizontal direction and the vertical direction by one pixel or by one subpixel. For example, the image sensor driving unit 123 causes the image sensor driving mechanism 122, which is an actuator, to shift the image sensor 121 in accordance with an instruction from the control unit 21.

In a case where the position or the attitude of the lens 111 is modified, the lens driving unit 222 may cause the lens driving mechanism 221 which is an actuator to shift the lens 111 in accordance with an instruction from the control unit 21.

The address-type defect correction processing unit 24 performs the address-type defect correction processing on images captured by the image sensor 121. The address-type defect correction processing unit 24 performs the address-type defect correction processing on a defective pixel indicated by an address (position) of the defective pixel stored in the defect address storing unit 201. The imaging device 1 may not include the address-type defect correction processing unit 24 or the defect address storing unit 201. The output unit 18, the memory unit 20, or the control unit 21 in FIG. 6 function as an association unit that performs the above-described “association” process. Other points are similar to those of the imaging device 1 illustrated in FIG. 3, and thus description thereof is omitted.

Note that some of the functions of the imaging device 1 described with reference to FIGS. 3 and 6 may be performed by the image processing device 70 such as a PC separate from the imaging device 1. For example, the imaging device 1 may perform processing up to the detection-type defect correction processing unit 13, and the image processing device 70 may perform processing from the composition processing unit 14 to the subsequent units. Furthermore, for example, the imaging device 1 may perform processing up to the interpolation target defective pixel determining unit 132, and the image processing device 70 may perform processing from the interpolation target defective pixel interpolating unit 133 to the subsequent units. In this manner, the image processing may be performed by the image processing device 70 as the image processing device TD and the imaging device 1. Note that the above is merely an example, and the sharing of functions between the imaging device 1 and the image processing device 70 is not limited to the above. Hereinafter, a case where an image processing system 50 including the imaging device 1 and the image processing device 70 performs processing will be described.

### 1-6. Processing Procedure by Image Processing System

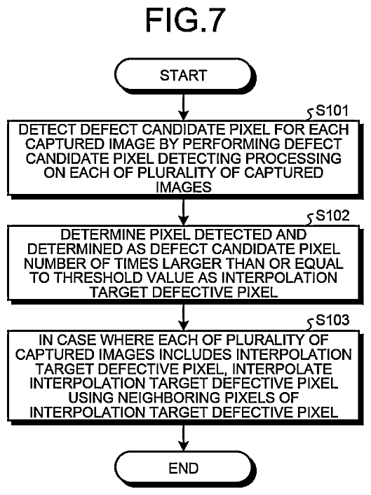

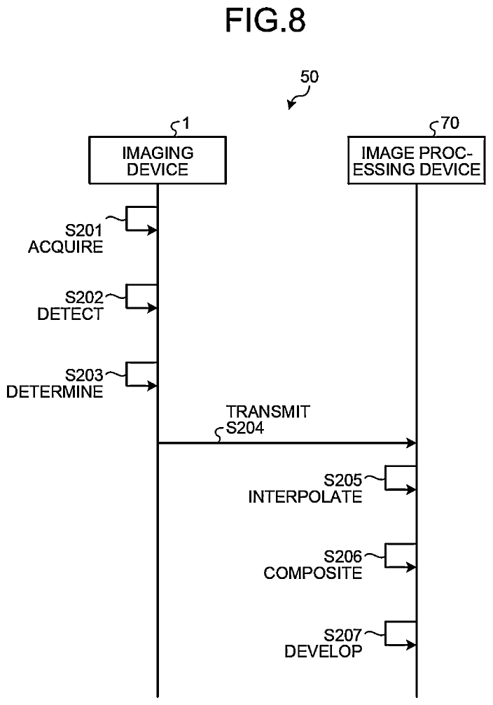

First, a processing procedure by the image processing system 50 will be described with reference to FIGS. 7 and 8. Hereinafter, processing in which the image processing system 50 is described as the subject of the processing may be performed by either the imaging device 1 or the image processing device 70 included in the image processing system 50.

First, the flow of processing by the image processing system will be described with reference to FIG. 7. FIG. 7 is a flowchart illustrating a processing procedure of the image processing system according to the embodiment of the present disclosure.

As illustrated in FIG. 7, the image processing system 50 detects a defect candidate pixel for each captured image by performing the defect candidate pixel detecting processing on each of a plurality of captured images (step S101). The image processing system 50 determines a pixel detected as a defect candidate pixel the number of times larger than or equal to a threshold value as an interpolation target defective pixel (step S102). In a case where each of the plurality of captured images includes an interpolation target defective pixel, the image processing system 50 interpolates the interpolation target defective pixel using neighboring pixels of the interpolation target defective pixel (step S103).

Next, an example of processing in a case where functions are shared by the imaging device 1 and the image processing device 70 included in the image processing system 50 will be described with reference to FIG. 8. FIG. 8 is a sequence diagram illustrating the processing procedure of the image processing system.

As illustrated in FIG. 8, the imaging device 1 acquires a plurality of captured images by imaging processing in the pixel-shifted high-image-quality imaging mode (step S201).

Then, the imaging device 1 performs the defect candidate pixel detecting processing (step S202). Note that the steps illustrated in FIG. 8 are symbols for convenience of describing the processing, and it is not limited to the case where step S202 is started after completion of step S201. The imaging device 1 may perform imaging processing for acquiring a next captured image while performing the defect candidate pixel detecting processing of a captured image. As described above, the imaging device 1 may execute step S201 and step S202 in parallel.

Then, the imaging device 1 performs the interpolation target defective pixel determining processing (step S203). The imaging device 1 compares the number of times (count value) each pixel is detected as a defect candidate pixel with a threshold value and determines a pixel detected as a defect candidate pixel the number of times larger than or equal to the threshold value as an interpolation target defective pixel.

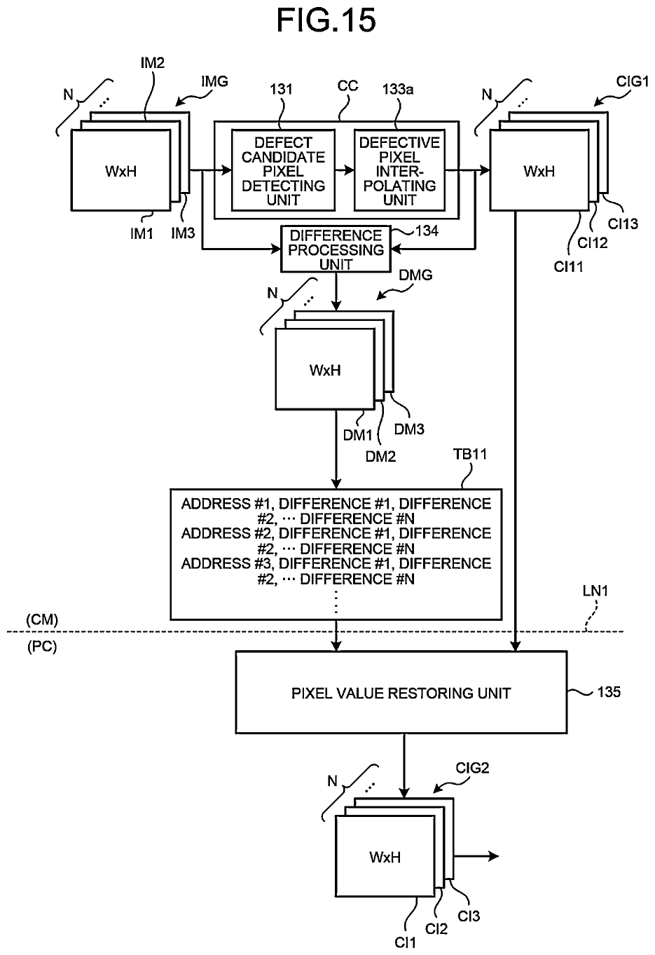

Then, the imaging device 1 transmits a plurality of captured images or interpolation target defective pixel information DPI indicating interpolation target defective pixels to the image processing device 70 (step S204). Note that the imaging device 1 may transmit a plurality of captured images subjected to the detection-type defect correction processing by the imaging device 1 itself or the interpolation target defective pixel information DPI to the image processing device 70 without transmitting a plurality of captured images not subjected to the detection-type defect correction processing of the present embodiment. This point will be described with reference to FIG. 15.

Then, the image processing device 70 that has received the information from the imaging device 1 performs the defective pixel interpolating processing on each of the interpolation target defective pixels of the captured image including the interpolation target defective pixels among the plurality of captured images (step S205).

Then, the image processing device 70 performs the high-image-quality composite processing (step S206). The image processing device 70 performs the high-image-quality composite processing by using an image subjected to the defective pixel interpolating processing for the image on which the defective pixel interpolating processing has been performed and using an image that is not processed for an image on which the defective pixel interpolating processing has not been performed.

Then, the image processing device 70 performs the development processing on the composite image combined by the high-image-quality composite processing (step S207).

### 1-7. Processing Example by Image Processing System

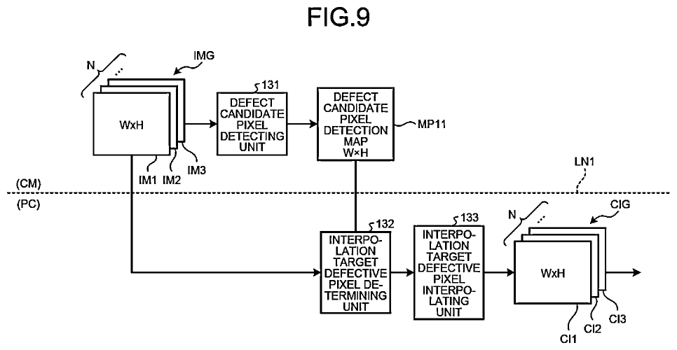

Hereinafter, a processing example by the image processing system 50 will be described with reference to FIGS. 9 to 15. Note that an interface LN1 indicated by a dotted line in FIGS. 9 to 15 indicates an example of a processing interface in a case where the imaging device 1 performs a first half of the processing and the image processing device 70 (for example, development software) performs the latter half of the processing in each of processing methods (variations) in FIGS. 9 to 15. Note that, as described later, the interface of the processing is not limited to the interface LN1, and various modes may be used.

### 1-7-1. First Processing Example

First, a first processing example will be described with reference to FIG. 9. FIG. 9 is a diagram illustrating an example of a processing overview by the image processing system. FIG. 9 is a diagram illustrating the first processing example.

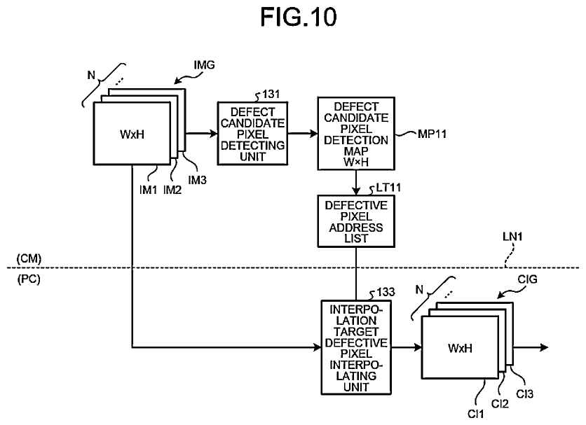

First, the premise of the diagram illustrated in FIG. 9 will be briefly described. An interface LN1 in FIG. 9 indicates an interface of processing in the image processing system 50 between the imaging device 1 side and the image processing device 70 side. A side (upper side) denoted by “(CM)” of the interface LN1 in FIG. 9 corresponds to the imaging device 1, and a side (lower side) denoted by “(PC)” of the interface LN1 in FIG. 9 corresponds to the image processing device 70. Note that the interface LN1 is an example, and each piece of processing may be performed by any device of the image processing system 50. For example, the imaging device 1 may perform all the pieces of processing illustrated in FIG. 9, or the image processing device 70 may perform all the pieces of processing illustrated in FIG. 9. The same applies also to FIGS. 10 to 15.

In FIG. 9, the upper side of the interface LN1 indicates processing by the imaging device 1 or information generated. In addition, the lower side of the interface LN1 in FIG. 9 indicates processing by the image processing device 70 or information generated. Meanwhile, an arrow across the interface LN1 in FIG. 9 indicates transmission and reception of information between devices. For example, an arrow extending from the defect candidate pixel detection map MP11 to the interpolation target defective pixel determining unit 132 in FIG. 9 indicates that the defect candidate pixel detection map MP11 is transmitted from the imaging device 1 to the image processing device 70.

First, an overview of the processing of FIG. 9 will be described. FIG. 9 is a diagram illustrating an overview of the detection-type defect correction processing in the first processing example. The defect candidate pixel detection map MP11 is generated by the defect candidate pixel detecting processing on a captured image group IMG by the defect candidate pixel detecting unit 131. The defect candidate pixel detection map MP11 in FIG. 9 has the same size as that of a RAW image (such as each of the captured images IM1 to IM3) for storing whether or not each pixel is detected as an interpolation target defective pixel. For example, the defect candidate pixel detection map MP11 is loaded on the memory 202 in FIG. 4. In the defect candidate pixel detection map, “1” is added (incremented) to an address of the memory corresponding to a pixel detected as a defect candidate pixel.

Here, for example, in a case of an actual defective pixel, after the captured images (N images in FIG. 9) are processed, the value (count value) at a corresponding address (position) on the defect candidate pixel detection map MP11 becomes larger than or equal to the threshold value. On the other hand, in a case of erroneous detection dependent on, for example, a subject other than an actual defective pixel, with the image sensor moving slightly, it may not be determined as a defect or not, and thus the numerical value is less likely to be greater than or equal to the threshold value. That is, in a case of erroneous detection, the value (count value) of a pixel corresponding to the erroneous detection is less than the threshold value. Moreover, the defective pixel interpolating processing by the interpolation target defective pixel interpolating unit 133 is applied only to a pixel whose count value is larger than or equal to the threshold value. Note that specific processing contents of the “defect candidate pixel detecting processing” or the “interpolation target defective pixel interpolating processing” may be similar to those of the above-described processing, however, it is not limited thereto.

Subsequently, each piece of processing will be specifically described with reference to FIG. 9. In the example of FIG. 9, illustrated is a case where the imaging device 1 performs processing on the captured image group IMG including N captured images of a size (number of pixels) of W×H. The captured image group IMG includes captured images of the number of times of shifting (the number of times of imaging) in imaging in the pixel-shifted high-image-quality imaging mode, such as the captured images IM1, IM2, and IM3.

The defect candidate pixel detecting unit 131 of the imaging device 1 performs the defect candidate pixel detecting processing on each pixel of each of the captured images of the captured image group IMG and generates the defect candidate pixel detection map MP11 indicating the number of times (count value) each pixel is detected as a defective pixel. The defect candidate pixel detection map MP11 has a size of width W×height H (W×H elements) corresponding to the size of each of the captured images of the captured image group IMG. For example, in the defect candidate pixel detection map MP11, the count values of all the pixels are initialized to 0 before the defect candidate pixel detecting processing, and 1 is added (incremented) to an address (count value) of a pixel detected as a defect candidate pixel. The imaging device 1 associates the captured image group IMG with the defect candidate pixel detection map MP11. The imaging device 1 transmits the defect candidate pixel detection map MP11 and the captured image group IMG to the image processing device 70. For example, in FIG. 9, the captured image group IMG and the defect candidate pixel detection map MP11 are associated with each other by any one of the recording control unit 16, the output unit 18, or the control unit 21 (see FIG. 3) or cooperation thereof and are transferred to the image processing device 70 (PC).

Then, using the captured image group IMG and the defect candidate pixel detection map MP11 received from the imaging device 1, the image processing device 70 performs the interpolation target defective pixel determining processing by the interpolation target defective pixel determining unit 132 or the defective pixel interpolating processing by the interpolation target defective pixel interpolating unit 133. The image processing device 70 determines a pixel whose value in the defect candidate pixel detection map MP11 is larger than or equal to the threshold value as an interpolation target defective pixel and applies the defective pixel interpolating processing using neighboring pixels only to the interpolation target defective pixel.

Then, the image processing device 70 generates a defect-corrected image group CIG including N images such as defect-corrected images CI1, CI2, and CI3 that are obtained by performing the defective pixel interpolating processing on the interpolation target defective pixel. Then, the image processing device 70 generates a final image (output image), which is an image after the high-image-quality composite processing and the development processing, by performing the high-image-quality composite processing and the development processing using the defect-corrected image group CIG. Note that, in a case where there is no need to perform display or the like, the development processing is unnecessary, and the composite image may be recorded, transmitted, or output.

### 1-7-2. Second Processing Example

Next, a second processing example will be described with reference to FIG. 10. FIG. 10 is a diagram illustrating an example of a processing overview by the image processing system. FIG. 10 is a diagram illustrating the second processing example. FIGS. 10 to 15 described below are variations (modifications) of FIG. 9. All of these achieve the same effects as those of FIG. 9. Note that description of points similar to those in FIG. 9 will be omitted as appropriate.

First, an overview of the processing of FIG. 10 will be described. FIG. 10 is a diagram illustrating a method of sending a defective pixel address list LT11 indicating addresses at which a defect has been detected to the latter half of the processing (the lower side of the interface LN1 in FIG. 10, that is, the image processing device 70 side) instead of the defect candidate pixel detection map MP11 having the same size as an image size. In this case, a reduction in the size of data to be sent to the latter half of the processing (image processing device 70) can be expected. Note that the size of the defective pixel address list LT11 to be transmitted is a variable length. Moreover, the defective pixel address list LT11 corresponds to the interpolation target defective pixel address described with reference to FIG. 4.

Hereinafter, differences from FIG. 9 will be mainly described with reference to FIG. 10. In the example of FIG. 10, the imaging device 1 generates a defective pixel address list LT11 from the defect candidate pixel detection map MP11. The configuration of the imaging device 1 that generates the defective pixel address list LT11 in FIG. 10 corresponds to that of the interpolation target defective pixel determining unit 132 (see FIG. 4). The imaging device 1 generates the defective pixel address list LT11 indicating addresses of pixels whose values in the defect candidate pixel detection map MP11 are larger than or equal to a threshold value. The imaging device 1 associates the captured image group IMG with the defective pixel address list LT11. The imaging device 1 transmits the defective pixel address list LT11 or the captured image group IMG to the image processing device 70.

Then, the image processing device 70 performs the defective pixel interpolating processing by the interpolation target defective pixel interpolating unit 133 using the captured image group IMG and the defect address list LT11 received from the imaging device 1. The image processing device 70 applies the defective pixel interpolating processing only to a pixel corresponding to an address included in the defective pixel address list LT11.

Then, the image processing device 70 generates the defect-corrected image group CIG including N images such as the defect-corrected images CI1, CI2, and CI3 in which a defective pixel is corrected. Then, the image processing device 70 generates a final image (output image) by performing the high-image-quality composite processing and the development processing using the defect-corrected image group CIG.

### 1-7-3. Third Processing Example

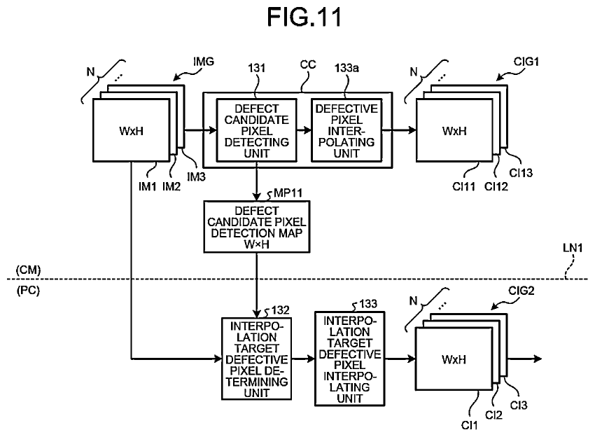

Next, a third processing example will be described with reference to FIG. 11. FIG. 11 is a diagram illustrating an example of a processing overview by the image processing system. FIG. 11 is a diagram illustrating the third processing example. Note that description of points similar to those in FIG. 9 or 10 will be omitted as appropriate.

First, an overview of the processing of FIG. 11 will be described. In FIG. 11, a case is assumed where a detection result of the defect candidate pixel detecting processing by the detection-type defect correcting circuit CC can be output from the detection-type defect correcting circuit CC, and the image processing device 70 can receive the detection result. The other points are similar to those of the image processing system 50 corresponding to FIG. 9.

Hereinafter, differences from FIG. 9 or 10 will be mainly described with reference to FIG. 11. In the example of FIG. 11, the imaging device 1 performs the detection-type defect correction on the captured image group IMG using the detection-type defect correcting circuit CC. The detection-type defect correcting circuit CC is a circuit (module) including the defect candidate pixel detecting unit 131 that performs the defect candidate pixel detecting processing and a defective pixel interpolating unit 133a that performs the defective pixel interpolating processing. Note that the detection-type defect correcting circuit CC may be software that executes the defect candidate pixel detecting processing by the defect candidate pixel detecting unit 131 and the defective pixel interpolating processing by the defective pixel interpolating unit 133a. Incidentally, the defective pixel interpolating processing by the defective pixel interpolating unit 133a of the detection-type defect correcting circuit CC is processing of correcting a pixel detected as a defect for each image. The defective pixel interpolating processing by the defective pixel interpolating unit 133a illustrated in FIG. 11 is similar to the interpolation step of the above-described comparative technology.

The detection-type defect correcting circuit CC performs the defect candidate pixel detecting processing on each image of the captured image group IMG by the defect candidate pixel detecting processing and generates the defect candidate pixel detection map MP11 on the basis of the result. The detection-type defect correcting circuit CC generates the defect candidate pixel detection map MP11 indicating the number of times (count value) each pixel is detected as a defect. For example, the detection-type defect correcting circuit CC generates the defect candidate pixel detection map MP11 which is a map having a size of W×H (W×H elements) corresponding to the size of each image of the captured image group IMG by the defect candidate pixel detecting processing.

The detection-type defect correcting circuit CC performs the defective pixel interpolating processing using the result of the defect candidate pixel detecting processing and performs the defective pixel interpolating processing on a defective pixel. As a result, the detection-type defect correcting circuit CC generates a defect-corrected image group CIG1 including N images such as defect-corrected images CI11, CI12, and CI13 in which a defective pixel is corrected. The detection-type defect correcting circuit CC outputs the defect-corrected image group CIG1. The detection-type defect correcting circuit CC can generate a defect-corrected image group CIG1 that is not subjected to composition and defect-corrected, and the imaging device 1 can acquire the defect-corrected image group CIG1.

The imaging device 1 acquires the defect candidate pixel detection map MP11 from the detection-type defect correcting circuit CC and transmits the acquired defect candidate pixel detection map MP11 or the captured image group IMG to the image processing device 70.

Then, using the captured image group IMG and the defect candidate pixel detection map MP11 received from the imaging device 1, the image processing device 70 performs the interpolation target defective pixel determining processing by the interpolation target defective pixel determining unit 132 or the defective pixel interpolating processing by the interpolation target defective pixel interpolating unit 133. The image processing device 70 applies the defective pixel interpolating processing only to a pixel whose value in the defect candidate pixel detection map MP11 is larger than or equal to the threshold value. In this case, the image processing device 70 applies the defective pixel interpolating processing only to a pixel detected as a defect in all the images of the captured image group IMG.

Then, the image processing device 70 generates a defect-corrected image group CIG2 including N images such as the defect-corrected images CI1, CI2, and CI3 in which a defective pixel is corrected. Then, the image processing device 70 generates a final image (output image) by performing the high-image-quality composite processing and the development processing using the defect-corrected image group CIG2.

### 1-7-4. Fourth Processing Example

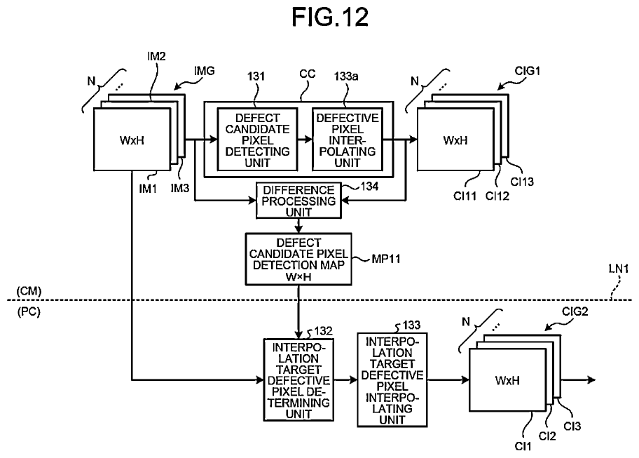

Next, a fourth processing example will be described with reference to FIG. 12. FIG. 12 is a diagram illustrating an example of a processing overview by the image processing system. FIG. 12 is a diagram illustrating the fourth processing example. Note that description of points similar to those in FIGS. 9 to 11 will be omitted as appropriate.

First, an overview of the processing of FIG. 12 will be described. FIG. 12 is a diagram illustrating a case where only input and output of the detection-type defect correcting circuit CC can be observed (information can be acquired). In other words, this is a case where the processing in the detection-type defect correcting circuit CC is in a black box. For example, it is based on the premise that the detection-type defect correcting circuit CC includes a signal processing IC manufactured by a third party or software (IP or the like) developed by a third party. The other points are similar to those of the image processing system 50 corresponding to FIG. 9. The image processing system 50 corresponding to FIG. 12 may be added with modification same as the modification from the image processing system 50 corresponding to FIG. 9 to the image processing system 50 corresponding to FIG. 10.

Hereinafter, differences from FIGS. 9 to 11 will be mainly described with reference to FIG. 12. In the example of FIG. 12, the imaging device 1 performs the detection-type defect correction on the captured image group IMG using the detection-type defect correcting circuit CC. The detection-type defect correcting circuit CC in FIG. 12 executes processing similar to that of the detection-type defect correcting circuit CC in FIG. 11 but is different from the detection-type defect correcting circuit CC in FIG. 11 in that the result of the defect candidate pixel detecting processing by the defect candidate pixel detecting unit 131 cannot be acquired. Note that, since the detection-type defect correcting circuit CC in FIG. 12 is a black box, the internal configuration may be any configuration as long as the defect-corrected image group CIG1 can be output when the captured image group IMG is input.

Using the detection-type defect correcting circuit CC, the imaging device 1 generates a defect-corrected image group CIG1 including N images such as the defect-corrected images CI11, CI12, and CI13 in which a defective pixel is corrected.

A difference processing unit 134 of the imaging device 1 obtains a difference between each pixel of each of the images of the captured image group IMG and a pixel of an image of the defect-corrected image group CIG1 corresponding to the image of the captured image group IMG. Note that, in a case where a pixel is detected as a defective pixel and is corrected, the difference is not zero, and thus it can be determined that the pixel whose difference is not zero has been detected as a defective pixel and defect correction has been performed. The difference processing unit 134 obtains a difference between each pixel of the captured image IM1 of the captured image group IMG and a pixel of the defect-corrected image CI11 of the defect-corrected image group CIG1 corresponding to the pixel of the captured image IM1. Then, the difference processing unit 134 adds “1” to the defect candidate pixel detection map MP11 for the pixel whose difference is not zero. Note that the difference is not limited to zero, and, for example, in consideration of noise or the like, “1” may be added in a case where the difference is a predetermined value. In addition, the difference processing unit 134 obtains a difference between each pixel of the captured image IM2 and a pixel of the defect-corrected image CI12 corresponding to the pixel of the captured image IM2. Then, the difference processing unit 134 adds “1” to the defect candidate pixel detection map MP11 for the pixel whose difference is not zero. The difference processing unit 134 repeats similar processing for the N images. In this manner, the imaging device 1 generates the defect candidate pixel detection map MP11 on the basis of a comparison result between the captured image group IMG and the defect-corrected image group CIG1. The difference processing unit 134 associates the captured image group IMG with the defect candidate pixel detection map MP11. The imaging device 1 transmits the generated defect candidate pixel detection map MP11 and the captured image group IMG to the image processing device 70.

Then, using the captured image group IMG and the defect candidate pixel detection map MP11 received from the imaging device 1, the image processing device 70 performs the interpolation target defective pixel determining processing by the interpolation target defective pixel determining unit 132 or the defective pixel interpolating processing by the interpolation target defective pixel interpolating unit 133. Since the subsequent processing is similar to that in FIG. 11, the description thereof will be omitted.

### 1-7-5. Fifth Processing Example

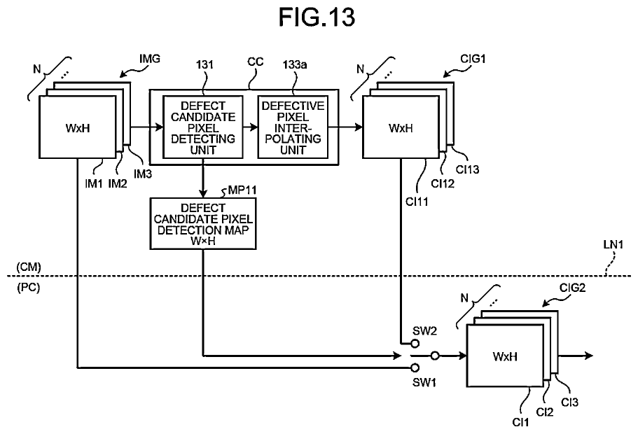

Next, a fifth processing example will be described with reference to FIG. 13. FIG. 13 is a diagram illustrating an example of a processing overview by the image processing system. FIG. 13 is a diagram illustrating the fifth processing example. Note that description of points similar to those in FIGS. 9 to 12 will be omitted as appropriate.

First, an overview of the processing of FIG. 13 will be described. In FIG. 13, a case is assumed where a detection result of the defect candidate pixel detecting processing by the detection-type defect correcting circuit CC can be output from the detection-type defect correcting circuit CC, and the image processing device 70 can receive the detection result. As described above, a detection-type defect correcting circuit CC in FIG. 13 is similar to the detection-type defect correcting circuit CC in FIG. 11.

Hereinafter, differences from FIGS. 9 to 12 will be mainly described with reference to FIG. 13. In the example of FIG. 13, the imaging device 1 performs the detection-type defect correction on the captured image group IMG using the detection-type defect correcting circuit CC.

The detection-type defect correcting circuit CC performs the defect candidate pixel detecting processing on each image of the captured image group IMG by the defect candidate pixel detecting processing by the defect candidate pixel detecting unit 131 and generates the defect candidate pixel detection map MP11 on the basis of the result. The detection-type defect correcting circuit CC also performs the defective pixel interpolating processing on a defective pixel by the defective pixel interpolating unit 133a by using the result of the defect candidate pixel detecting processing by the defect candidate pixel detecting unit 131. As a result, the detection-type defect correcting circuit CC generates a defect-corrected image group CIG1 including N images such as defect-corrected images CI11, CI12, and CI13 in which a defective pixel is corrected. The detection-type defect correcting circuit CC outputs the defect-corrected image group CIG1.

Furthermore, as described above, the imaging device 1 can transmit the result of the defect candidate pixel detecting processing by the defect candidate pixel detecting unit 131 of the detection-type defect correcting circuit CC to the image processing device 70. The imaging device 1 associates the captured image group IMG with the defect candidate pixel detection map MP11. The imaging device 1 acquires the defect candidate pixel detection map MP11 from the detection-type defect correcting circuit CC and associates the captured image group IMG, the defect candidate pixel detection map MP11, and the defect-corrected image group CIG1. The imaging device 1 transmits the defect candidate pixel detection map MP11, the captured image group IMG, or the defect-corrected image group CIG1 to the image processing device 70.

Then, the image processing device 70 selects a switch SW1 for a pixel for which the captured image group IMG is used and selects a switch SW2 for a pixel for which the defect-corrected image group CIG1 is used, thereby generating the defect-corrected image group CIG2. The image processing device 70 selects the switch SW2 for a pixel whose value in the defect candidate pixel detection map MP11 is larger than or equal to the threshold value. That is, the image processing device 70 uses a corrected pixel of the defect-corrected image group CIG1 for a pixel whose value in the defect candidate pixel detection map MP11 is larger than or equal to the threshold value, that is, for a defective pixel, and uses an uncorrected pixel of the captured image group IMG for a pixel that is not a defective pixel. The image processing device 70 may include a selection unit that performs selection by the switches SW1 and SW2.

As a result, the image processing device 70 generates the defect-corrected image group CIG2 including N images such as the defect-corrected images CI1, CI2, and CI3 in which a defective pixel is corrected. Then, the image processing device 70 generates a final image (output image) by performing the high-image-quality composite processing and the development processing using the defect-corrected image group CIG. Note that the image processing device 70 may receive only information necessary for generation of the defect-corrected image group CIG2 from the imaging device 1. In this case, the image processing device 70 may request the image selected for each pixel to the imaging device 1 and may receive information of the pixel of the selected image from the imaging device 1.

### 1-7-6. Sixth Processing Example

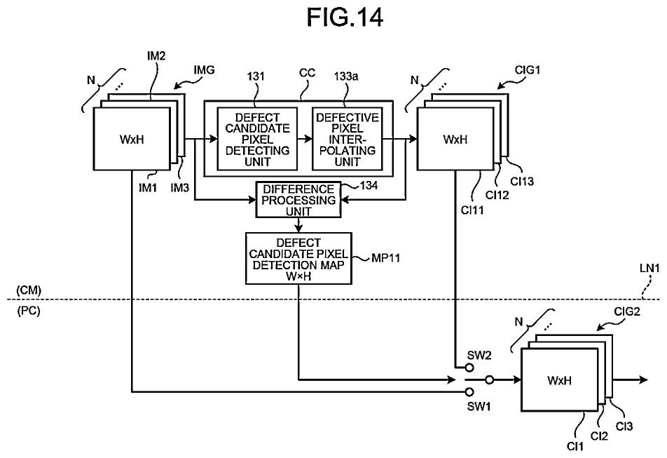

Next, a sixth processing example will be described with reference to FIG. 14. FIG. 14 is a diagram illustrating an example of a processing overview by the image processing system. FIG. 14 is a diagram illustrating the sixth processing example. Note that description of points similar to those in FIGS. 9 to 13 will be omitted as appropriate.

First, an overview of the processing of FIG. 14 will be described. In FIG. 14, a case is assumed where the imaging device 1 cannot access information other than images before correction and images after correction. As described above, the detection-type defect correcting circuit CC in FIG. 14 is a black box and outputs only a defect-corrected image group CIG1.

Hereinafter, differences from FIGS. 9 to 13 will be mainly described with reference to FIG. 14. In the example of FIG. 14, the imaging device 1 performs the detection-type defect correction on the captured image group IMG using the detection-type defect correcting circuit CC.

Using the detection-type defect correcting circuit CC, the imaging device 1 generates a defect-corrected image group CIG1 including N images such as the defect-corrected images CI11, CI12, and CI13 in which a defective pixel is corrected.

The difference processing unit 134 the difference processing unit 134 of the imaging device 1 generates the defect candidate pixel detection map MP11 by processing similar to that in FIG. 12, such as obtaining a difference between each pixel of each image of the captured image group IMG and a pixel of an image of the defect-corrected image group CIG1 corresponding to the image of the captured image group IMG. The difference processing unit 134 associates the captured image group IMG with the defect candidate pixel detection map MP11. The imaging device 1 transmits the defect candidate pixel detection map MP11 that has been generated, the captured image group IMG, or the defect-corrected image group CIG1 to the image processing device 70.

Then, the image processing device 70 selects a switch SW1 for a pixel for which the captured image group IMG is used and selects a switch SW2 for a pixel for which the defect-corrected image group CIG1 is used, thereby generating the defect-corrected image group CIG2. Since the subsequent processing is similar to that in FIG. 13, the description thereof will be omitted.

In addition, in FIGS. 13 and 14, in a mode in which the processing below the interface LN1 (latter half of the processing) is executed by development software on a PC (the image processing device 70 or the like) as illustrated, the processing on the PC side can be reduced.

### 1-7-7. Seventh Processing Example

Next, a seventh processing example will be described with reference to FIG. 15. FIG. 15 is a diagram illustrating an example of a processing overview by the image processing system. FIG. 15 is a diagram illustrating the seventh processing example. Note that description of points similar to those in FIGS. 9 to 14 will be omitted as appropriate.

First, an overview of the processing of FIG. 15 will be described. FIG. 15 is a diagram illustrating an exemplary case where processing is enabled without including an image before defect correction in data to be sent from a camera to a PC. Illustrated in FIG. 15 is a method of generating a table of addresses of pixels determined as defects and absolute values of differences between pixel values after interpolation and pixel values before interpolation of the pixels and sending the table to an output stage (image processing device 70).

Hereinafter, differences from FIGS. 9 to 14 will be mainly described with reference to FIG. 15. In the example of FIG. 15, the imaging device 1 performs the detection-type defect correction on the captured image group IMG using a detection-type defect correcting circuit CC. The detection-type defect correcting circuit CC in FIG. 15 is similar to the detection-type defect correcting circuit CC in FIG. 12.

Using the detection-type defect correcting circuit CC, the imaging device 1 generates a defect-corrected image group CIG1 including N images such as the defect-corrected images CI11, CI12, and CI13 in which a defective pixel is corrected.

The difference processing unit 134 of the imaging device 1 performs difference processing of obtaining a difference between pixels at corresponding positions between each image of the captured image group IMG and an image of the defect-corrected image group CIG1 corresponding to the image of the captured image group IMG and generates a difference map including all the differences.

In FIG. 15, the imaging device 1 generates a difference map group DMG including a plurality of difference maps which are maps having a size of height H×width W (H×W elements) corresponding to the size of each image of the captured image group IMG by the difference processing. For example, the imaging device 1 generates a difference map DM1 indicating a difference of each pixel between the captured image IM1 of the captured image group IMG and the defect-corrected image CI11 of the defect-corrected image group CIG1. The imaging device 1 generates the difference map DM1 by subtracting, from a pixel value of each pixel of the defect-corrected image CI11, a pixel value of a pixel of the captured image IM1 corresponding to the pixel of the defect-corrected image CI11. The imaging device 1 repeats similar processing for the N images. As a result, the imaging device 1 generates the difference map group DMG including a plurality of difference maps such as difference maps DM1 to DM3.

Then, the imaging device 1 generates a table (also referred to as an “address-difference table TB11”) for pixels having values other than zero in a number of images greater than or equal to the threshold value. Note that it is not limited to the case where the value is zero, and the address-difference table TB11 may be generated for pixels having a predetermined value in a number of images greater than or equal to the threshold value in consideration of noise or the like, for example. The address-difference table TB11 is information in which information (address) specifying each pixel is associated with information (difference) indicating a difference in each image. For example, the address-difference table TB11 includes information in which N differences such as a difference #1 indicating a difference of a first image combination (the captured image IM1 and the defect-corrected image CI11) and a difference #2 indicating a difference of a second image combination (the captured image IM2 and the defect-corrected image CI12) are associated with an address #1 specifying one pixel.

As described above, the data size necessary for the address-difference table TB11 is variable. Meanwhile, by sorting the pixels included in the address-difference table TB11 in the descending order of absolute values of the differences and sending only addresses of pixels in higher ranks, the table size can be set to a fixed length, and the data size can be reduced at the same time. In this case, a pixel having a small absolute value of differences, that is, a defect on a small level is not corrected.

The imaging device 1 associates the defect-corrected image group CIG1 with the address-difference table TB11. The imaging device 1 transmits the address-difference table TB11 or the defect-corrected image group CIG1 to the image processing device 70. Note that, in a case where the image processing device 70 does not have information such as the positional relationship of each image of the defect-corrected image group CIG1, the imaging device 1 may transmit metadata indicating the positional relationship or the like of each image of the defect-corrected image group CIG1 to the image processing device 70.

Then, a pixel value restoring unit 135 of the image processing device 70 restores pixel values before correction using the defect-corrected image group CIG1 received from the imaging device 1 and the address-difference table TB11. The pixel value restoring unit 135 generates (restores) the pixel values before correction from the difference information for the pixels at the addresses recorded in the address-difference table TB11. For example, the pixel value restoring unit 135, by using the address of a pixel indicated by the address-difference table TB11 and differences of the pixel, subtracts the differences from the pixel value of the pixel in the defect-corrected image group CIG1 and thereby restores the pixel value of the pixel in the captured image group IMG. As a result, the image processing device 70 generates the defect-corrected image group CIG2 including N images such as the defect-corrected images CI1, CI2, and CI3 in which pixel values of pixels indicated by the address-difference table TB11, among the pixels in the defect-corrected image group CIG1, are restored before correction. Then, the image processing device 70 generates a final image (output image) by performing the high-image-quality composite processing and the development processing using the defect-corrected image group CIG2.

Note that the numerical values in the address-difference table TB11 may be the original pixel values instead of the absolute values of the differences. Even in a mode in which N RAW images (data) are recorded for a higher image quality with pixel-shifting and sent to a PC, there is also a use case in which development with normal resolution is performed using only one of the N RAW images. Therefore, according to the method of FIG. 15, since all the N RAW images to be sent to the PC have been defect-corrected, in a case where development with the normal resolution is performed using only one of the N RAW images, no special processing is required, and it can be handled completely in the same manner as that for one RAW image (data) that is normally imaged. Furthermore, not limited to the example of FIG. 15, in a case where only one of the N RAW images captured for a higher image quality is used, if defect detection is performed from the N RAW images by the method described above, erroneous detection of a defective pixel can be reduced, and by performing correction by applying the defect detection result, a better image quality with reduced degradation of contrast or coloring can be obtained.

As described above, for each of FIGS. 9 to 15, all may be performed on a camera (imaging device 1). Alternatively, for each of FIGS. 9 to 15, all may be performed on development processing software of a PC (image processing device 70). Further alternatively, the first half of the processing may be performed on a camera (imaging device 1), and the latter half of the processing may be performed on development processing software of a PC (image processing device 70). That is, the interface LN1 illustrated in FIGS. 9 to 15 is an example of the interface, and it is not limited to setting an interface of the system to the interface LN1.

### 2. Other Embodiments

The processing according to the above embodiments may be performed in various different modes (modifications) other than in the above embodiments or modifications.

### 2-1. Others

Among the processing described in the above embodiments, the whole or a part of the processing described as that performed automatically can be performed manually, or the whole or a part of the processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information illustrated.

In addition, each component of each device illustrated in the drawings is conceptual in terms of function and does not need to be necessarily physically configured as illustrated in the drawings. That is, a specific form of distribution or integration of each device is not limited to those illustrated in the drawings, and the whole or a part thereof can be functionally or physically distributed or integrated in any unit depending on various loads, usage status, and others.

In addition, the above embodiments and modifications can be combined as appropriate within a range where there is no conflict in the processing content.

Furthermore, the effects described herein are merely examples and are not limiting, and other effects may be achieved.

### 3. Effects of Present Disclosure

As described above, the image processing device (imaging device 1 in the embodiment) according to the present disclosure includes the defect candidate pixel detecting unit (defect candidate pixel detecting unit 131 in the embodiment) and the interpolation target defective pixel determining unit (interpolation target defective pixel determining unit 132 in the embodiment). The defect candidate pixel detecting unit detects a defect candidate pixel for each of a plurality of captured images captured in a state where positional relationships between an imaging range and the image sensor including a plurality of pixels are caused to be different from each other by performing the defect candidate pixel detecting processing on each of the plurality of captured images. The interpolation target defective pixel determining unit determines, as an interpolation target defective pixel, a pixel detected as a defect candidate pixel a number of times greater than or equal to a threshold value by the defect candidate pixel detecting unit.

As described above, the image processing device according to the present disclosure detects a defect candidate pixel for each of the plurality of captured images by performing the defect candidate pixel detecting processing on each of the plurality of captured images and determines a pixel detected as a defect candidate pixel a number of times greater than or equal to the threshold value as an interpolation target defective pixel, thereby enabling appropriate determination of a defective pixel and prevention of deterioration in the quality of an image obtained in the pixel-shifted high-image-quality imaging mode.

The threshold value is less than or equal to the number of the plurality of captured images. In this manner, the image processing device can appropriately determine the interpolation target defective pixel depending on the number of the plurality of captured images by using the threshold value which is less than or equal to the number of the plurality of captured images.

The threshold value is less than the number of the plurality of captured images. In this manner, the image processing device can appropriately determine the interpolation target defective pixel depending on the number of the plurality of captured images by using the threshold value which is less than the number of the plurality of captured images.

The defect candidate pixel detecting unit detects whether or not each of pixels of interest in each of the plurality of captured images is a defect candidate pixel on the basis of a comparison result between a pixel value of each of the pixels of interest and a pixel value of a detection neighboring pixel that is a neighboring pixel of each of the pixels of interest. As described above, the image processing device can appropriately detect a defect candidate pixel by detecting whether or not each pixel of interest is a defect candidate pixel on the basis of the comparison result between a pixel value of each pixel of interest and pixel values of neighboring pixels.

The interpolation target defective pixel determining unit determines a pixel of interest as an interpolation target defective pixel in a case where polarities of differences between the pixel of interest and each of a plurality of detection neighboring pixels are the same and absolute values of the differences exceed a threshold value and in a case where the pixel of interest is determined as a defect candidate pixel a number of times greater than or equal to a threshold value by the defect candidate pixel detecting processing of detecting the pixel of interest as a defect candidate pixel. In this manner, the image processing device can appropriately detect a defect candidate pixel by detecting a defect candidate pixel using the polarities of the differences between the pixel of interest and each of the plurality of detection neighboring pixels.

The image processing device includes the interpolation target defective pixel interpolating unit (interpolation target defective pixel interpolating unit 133 in the embodiment). The interpolation target defective pixel interpolating unit outputs a plurality of defect-corrected images corresponding to the plurality of captured images by interpolating the interpolation target defective pixel with an interpolation neighboring pixel that is a neighboring pixel of an interpolation target defective pixel in a case where each of the plurality of captured images includes the interpolation target defective pixel. As described above, the image processing device can interpolate the interpolation target defective pixel appropriately by interpolating the interpolation target defective pixel using neighboring pixels of the interpolation target defective pixel.

The interpolation target defective pixel interpolating unit interpolates the interpolation target defective pixel using a pixel included in the same captured image as a captured image of the interpolation target defective pixel as interpolation neighboring pixels. As described above, the image processing device can appropriately interpolate the interpolation target defective pixel by interpolating the interpolation target defective pixel using pixels included in the same captured image as that of the interpolation target defective pixel.

The image processing device includes a composition unit (composition processing unit 14 in the embodiment). The composition unit sets, among the plurality of captured images, for a captured image determined by the interpolation target defective pixel determining unit to include an interpolation target defective pixel, a captured image subjected to interpolation of the interpolation target defective pixel by the interpolation target defective pixel interpolating unit as a composition target image and, for an image determined not to include an interpolation target defective pixel by the interpolation target defective pixel determining unit, sets the image as a composition target image and then generates a composite image having a higher image quality than image quality of each of a plurality of composition target images by performing composite processing (high-image-quality composite processing) using the plurality of composition target images. In this manner, the image processing device can generate a composite image having higher image quality than those of the images before the composition.

The composite image has a larger number of pixels than that of each of the plurality of captured images. For example, an image obtained by imaging 8 images, 16 images, or more images, for example, with a shift amount of less than one pixel and combining these images has a larger number of pixels than an image developed by a normal method using one of the plurality of captured images. In this manner, the image processing device can generate a composite image having a larger number of pixels than those of the images before the composition.

The composite image has a higher color resolution than that of each of the plurality of captured images. For example, an image obtained by combining images obtained by capturing images four times with a shift by one pixel has higher oblique resolution and color resolution than those of an image obtained by developing one of the four images by a normal method. In this manner, the image processing device can generate a composite image having a higher color resolution than those of the images before the composition.

The image processing device calculates a difference between pixels at positions corresponding to each other between each of the plurality of captured images and a defect-corrected image corresponding to the captured image among the plurality of defect-corrected images and generates the interpolation target defective pixel information (interpolation target defective pixel information DPI) indicating that a pixel whose difference is greater than or equal to a predetermined value is a defective pixel. As described above, the image processing device can generate the interpolation target defective pixel information indicating interpolation target defective pixels by using the differences of pixels between the plurality of captured images and the defect-corrected images after the interpolation processing.

The image processing device includes the association unit (difference processing unit 134 in the embodiment). The association unit associates the plurality of captured images with the interpolation target defective pixel information. As described above, the image processing device can allow an interpolation target pixel to be specified among the pixels of the plurality of captured images based on association by associating the plurality of captured images with the interpolation target defective pixel information.

The plurality of captured images is obtained by capturing images in a state in which positional relationships between the imaging range and the image sensor are caused to be different from each other by a pixel or a subpixel. The image processing device can appropriately determine an interpolation target defective pixel for the plurality of captured images captured with positional relationships different by one pixel or by one subpixel.

The defect candidate pixel detecting unit detects a defect candidate pixel for each of a plurality of captured images captured in a state where positional relationships between an imaging range and the image sensor including a plurality of pixels are caused to be different from each other by performing the defect candidate pixel detecting processing on each of the plurality of captured images. The association unit (the recording control unit 16, the output unit 18, the memory unit 20, the control unit 21, or others in the embodiment) associates the captured images with the detection result of the defect candidate pixel detecting unit. As described above, the image processing device can allow a defect candidate pixel to be specified among the pixels of the plurality of captured images based on association by associating the plurality of captured images with the detection result of defect candidate pixels.

The detection result is defect candidate pixel detection information (defect candidate pixel detection map) indicating a number of times each pixel of the captured images is detected as a defect candidate pixel by the defect candidate pixel detecting unit. As described above, by associating the plurality of captured images with the defect candidate pixel detection information indicating the number of times of detection as a defect candidate pixel, the image processing device can allow the number of times each pixel of the plurality of captured images has been detected as a defect candidate pixel to be specified on the basis of the association.

The interpolation target defective pixel determining unit determines, as an interpolation target defective pixel, a pixel detected as a defect candidate pixel a number of times greater than or equal to a threshold value by the defect candidate pixel detecting unit. As described above, the image processing device can prevent deterioration in the quality of an image obtained in the pixel-shifted high-image-quality imaging mode by determining a pixel detected as a defect candidate pixel a number of times greater than or equal to the threshold value as an interpolation target defective pixel and thereby appropriately determining a defective pixel.

The detection result is interpolation target defective pixel address information (interpolation target defective pixel address list) indicating the addresses of interpolation target defective pixels. As described above, the image processing device can allow an address of an interpolation target defective pixel to be specified on the basis of association by associating the plurality of captured images with the interpolation target defective pixel address information indicating addresses of interpolation target defective pixels.

The association unit associates the address difference information with the plurality of defect-corrected images, the address difference information indicating addresses of pixels, of the highest rank to a predetermined rank in a descending order of absolute values of differences among absolute values of a plurality of differences calculated for pixels at positions corresponding to each other in the plurality of captured images and the plurality of defect-corrected images, and the differences. As described above, the image processing device can allow an image to which the address difference information is applied to be specified by associating the address difference information, indicating the addresses of the pixels having larger absolute values of the differences and the differences, with the plurality of defect-corrected images. As a result, a reception-side device that has received the address difference information from the image processing device can specify the image to which the address difference information is applied and apply the address difference information to the image. The image processing device can also suppress an increase in the data amount to be transmitted to an external device by using the address difference information.

The image processing device includes the pixel value restoring unit (pixel value restoring unit 135 in the embodiment). The pixel value restoring unit restores a pixel value of a pixel in the plurality of captured images by using address difference information indicating an address of the pixel, an absolute value of a difference calculated for which at positions corresponding to each other in a plurality of defect-corrected images corresponding to one of the plurality of captured images and the plurality of captured images is greater than or equal to a predetermined value, and differences for the pixel and the plurality of defect-corrected images. As described above, the image processing device can restore the pixel value of the pixel in the plurality of captured images from the plurality of defect-corrected images by using the address difference information.

### 4. Hardware Configuration

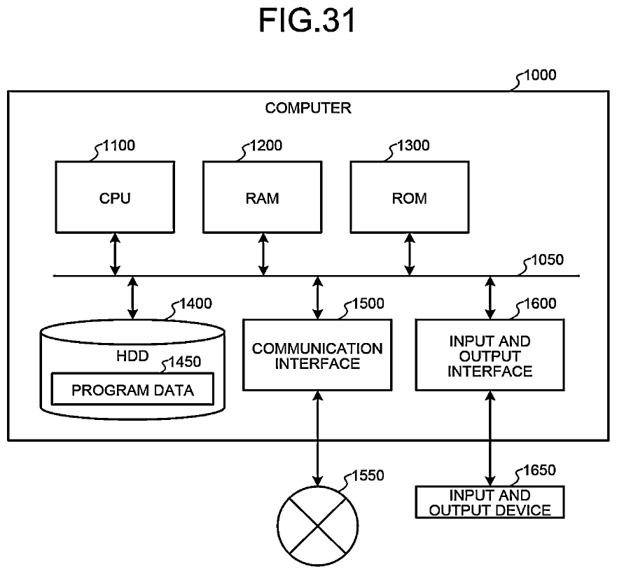

An information device such as the image processing device TD according to the embodiments described above is implemented by, for example, a computer 1000 having a configuration as illustrated in FIG. 31. FIG. 31 is a hardware configuration diagram illustrating an example of the computer 1000 that implements the functions of the image processing device such as the image processing device TD. Hereinafter, the imaging device 1 according to the embodiment will be described as an example. The computer 1000 includes a CPU 1100, a RAM 1200, a ROM 1300, an HDD 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records an image processing program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display, a speaker, or a printer via the input and output interface 1600. Furthermore, the input and output interface 1600 may function as a media interface that reads a program or the like recorded in a recording medium. A recording medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the imaging device 1 according to the embodiment, the CPU 1100 of the computer 1000 implements the function of the control unit 21 or other units by executing the image processing program loaded on the RAM 1200. Meanwhile, the HDD 1400 stores the image processing program according to the present disclosure or data in the memory unit 20. Note that although the CPU 1100 reads the program data 1450 from the HDD 1400 and executes the program data 1450, as another example, these programs may be acquired from another device via the external network 1550.

Note that the present technology can also have the following configurations.

(1)

An Image Processing Device Comprising:

a defect candidate pixel detecting unit that detects a defect candidate pixel for each of captured images captured in a state where positional relationships between an imaging range and an image sensor comprising a plurality of pixels are caused to be different from each other by performing defect candidate pixel detecting processing on each of the plurality of captured images; and

an interpolation target defective pixel determining unit that determines, as an interpolation target defective pixel, a pixel detected as the defect candidate pixel a number of times greater than or equal to a threshold value by the defect candidate pixel detecting unit.

(2)

The image processing device according to (1),

wherein the threshold value is

less than or equal to the number of the plurality of captured images.

(3)

The image processing device according to (1),

wherein the threshold value is

less than the number of the plurality of captured images.

(4)

The image processing device according to any one of (1) to (3),

wherein the defect candidate pixel detecting unit

detects whether or not each of pixels of interest in each of the plurality of captured images is the defect candidate pixel on a basis of a comparison result between a pixel value of the pixel of interest and a pixel value of a detection neighboring pixel that is a neighboring pixel of each of the pixel of interest.

(5)

The image processing device according to (4),

wherein the interpolation target defective pixel determining unit

determines the pixel of interest as the interpolation target defective pixel in a case where polarities of differences between the pixel of interest and each of a plurality of the detection neighboring pixels are same and absolute values of the differences exceed a threshold value and in a case where the pixel of interest is determined to be the defect candidate pixel a number of times greater than or equal to the threshold value by the defect candidate pixel detecting processing of detecting the pixel of interest as the defect candidate pixel.

(6)

The image processing device according to any one of (1) to (5), further comprising:

an interpolation target defective pixel interpolating unit that outputs a plurality of defect-corrected images corresponding to the plurality of captured images by interpolating the interpolation target defective pixel with an interpolation neighboring pixel that is a neighboring pixel of the interpolation target defective pixel in a case where each of the plurality of captured images includes the interpolation target defective pixel.

(7)

The image processing device according to (6),

wherein the interpolation target defective pixel interpolating unit

interpolates the interpolation target defective pixel using a pixel included in a same captured image as a captured image of the interpolation target defective pixel as the interpolation neighboring pixel.

(8)

The image processing device according to (6) or (7), further comprising:

a composition unit that sets,

among the plurality of captured images,

for a captured image determined by the interpolation target defective pixel determining unit to include the interpolation target defective pixel, a captured image subjected to interpolation of the interpolation target defective pixel by the interpolation target defective pixel interpolating unit as a composition target image and,

for a captured image determined not to include the interpolation target defective pixel by the interpolation target defective pixel determining unit, the captured image as a composition target image and then

generates a composite image having a higher image quality than image quality of each of a plurality of the composition target images by performing composite processing using the plurality of composition target images.

(9)

The image processing device according to (8),

wherein the composite image has

a larger number of pixels than a number of pixels of each of the plurality of captured images.

(10)

The image processing device according to (8) or (9),

wherein the composite image has

a higher color resolution than a color resolution of each of the plurality of captured images.

(11)

The image processing device according to any one of (6) to (10),

wherein a difference between pixels at positions corresponding to each other between each of the plurality of captured images and a defect-corrected image corresponding to the captured image among the plurality of defect-corrected images is calculated, and interpolation target defective pixel information is generated, the interpolation target defective pixel information indicating that a pixel whose difference is greater than or equal to a predetermined value is a defective pixel.

(12)

The image processing device according to (11), further comprising:

an association unit that associates the plurality of captured images with the interpolation target defective pixel information.

(13)

The image processing device according to any one of (1) to (12),

wherein the plurality of captured images is

obtained by capturing images in a state in which positional relationships between the imaging range and the image sensor are caused to be different from each other by a pixel or a subpixel.

(14)

An image processing device comprising:

a defect candidate pixel detecting unit that detects a defect candidate pixel for each of captured images captured in a state where positional relationships between an imaging range and an image sensor comprising a plurality of pixels are caused to be different from each other by performing defect candidate pixel detecting processing on each of the plurality of captured images; and

an association unit that associates the captured images and a detection result of the defect candidate pixel detecting unit.

(15)

The image processing device according to (14),

wherein the detection result is

defect candidate pixel detection information indicating a number of times each pixel of the captured images is detected as the defect candidate pixel by the defect candidate pixel detecting unit.

(16)

The image processing device according to (14) or (15), further comprising:

an interpolation target defective pixel determining unit that determines, as an interpolation target defective pixel, a pixel detected as the defect candidate pixel a number of times greater than or equal to a threshold value by the defect candidate pixel detecting unit.

(17)

The image processing device according to (16),

wherein the detection result is

interpolation target defective pixel address information indicating an address of the interpolation target defective pixel.

(18)

The image processing device according to any one of (6) to (12), further comprising:

an association unit that associates address difference information with the plurality of defect-corrected images, the address difference information indicating addresses of pixels, of a highest rank to a predetermined rank in a descending order of absolute values of differences among absolute values of a plurality of differences calculated for pixels at positions corresponding to each other in the plurality of captured images and the plurality of defect-corrected images, and the differences.

(19)

An image processing device comprising:

a pixel value restoring unit that restores a pixel value of a pixel in a plurality of captured images by using address difference information indicating an address of the pixel, an absolute value of a difference calculated for which at positions corresponding to each other in a plurality of defect-corrected images corresponding to one of the plurality of captured images and the plurality of captured images is greater than or equal to a predetermined value, and differences for the pixel and the plurality of defect-corrected images.

(20)

An image processing method of executing control of:

detecting a defect candidate pixel for each of a plurality of captured images captured in a state where positional relationships between an imaging range and an image sensor comprising a plurality of pixels are caused to be different from each other by performing defect candidate pixel detecting processing on each of the plurality of captured images; and

determining, as an interpolation target defective pixel, a pixel detected as the defect candidate pixel a number of times greater than or equal to a threshold value.

(21)

An image processing program of executing control of:

detecting a defect candidate pixel for each of captured images captured in a state where positional relationships between an imaging range and an image sensor comprising a plurality of pixels are caused to be different from each other by performing defect candidate pixel detecting processing on each of the plurality of captured images; and

determining, as an interpolation target defective pixel, a pixel detected as the defect candidate pixel a number of times greater than or equal to a threshold value.

### REFERENCE SIGNS LIST

1 IMAGING DEVICE
11 LENS SYSTEM
12 IMAGING ELEMENT UNIT
121 IMAGE SENSOR
13 DETECTION-TYPE DEFECT CORRECTION PROCESSING UNIT
131 DEFECT CANDIDATE PIXEL DETECTING UNIT
132 INTERPOLATION TARGET DEFECTIVE PIXEL DETERMINING UNIT
133 INTERPOLATION TARGET DEFECTIVE PIXEL INTERPOLATING UNIT
14 COMPOSITION PROCESSING UNIT
15 DEVELOPMENT PROCESSING UNIT
16 RECORDING CONTROL UNIT
17 DISPLAY UNIT
18 OUTPUT UNIT
19 OPERATION UNIT
20 MEMORY UNIT
21 CONTROL UNIT
22 DRIVER UNIT
23 SENSOR UNIT
50 IMAGE PROCESSING SYSTEM
70 IMAGE PROCESSING DEVICE

1. An image processing device comprising:
a defect candidate pixel detecting unit that detects a defect candidate pixel for each of captured images captured in a state where positional relationships between an imaging range and an image sensor comprising a plurality of pixels are caused to be different from each other by performing defect candidate pixel detecting processing on each of the plurality of captured images; and
an interpolation target defective pixel determining unit that determines, as an interpolation target defective pixel, a pixel detected as the defect candidate pixel a number of times greater than or equal to a threshold value by the defect candidate pixel detecting unit.

2. The image processing device according to claim 1,
wherein the threshold value is
less than or equal to the number of the plurality of captured images.

3. The image processing device according to claim 1,
wherein the threshold value is
less than the number of the plurality of captured images.

4. The image processing device according to claim 1,
wherein the defect candidate pixel detecting unit
detects whether or not each of pixels of interest in each of the plurality of captured images is the defect candidate pixel on a basis of a comparison result between a pixel value of the pixel of interest and a pixel value of a detection neighboring pixel that is a neighboring pixel of each of the pixel of interest.

5. The image processing device according to claim 4,
wherein the interpolation target defective pixel determining unit
determines the pixel of interest as the interpolation target defective pixel in a case where polarities of differences between the pixel of interest and each of a plurality of the detection neighboring pixels are same and absolute values of the differences exceed a threshold value and in a case where the pixel of interest is determined to be the defect candidate pixel a number of times greater than or equal to the threshold value by the defect candidate pixel detecting processing of detecting the pixel of interest as the defect candidate pixel.

6. The image processing device according to claim 1, further comprising:
an interpolation target defective pixel interpolating unit that outputs a plurality of defect-corrected images corresponding to the plurality of captured images by interpolating the interpolation target defective pixel with an interpolation neighboring pixel that is a neighboring pixel of the interpolation target defective pixel in a case where each of the plurality of captured images includes the interpolation target defective pixel.

7. The image processing device according to claim 6,
wherein the interpolation target defective pixel interpolating unit
interpolates the interpolation target defective pixel using a pixel included in a same captured image as a captured image of the interpolation target defective pixel as the interpolation neighboring pixel.

8. The image processing device according to claim 6, further comprising:
a composition unit that sets,
among the plurality of captured images,
for a captured image determined by the interpolation target defective pixel determining unit to include the interpolation target defective pixel, a captured image subjected to interpolation of the interpolation target defective pixel by the interpolation target defective pixel interpolating unit as a composition target image and,
for a captured image determined not to include the interpolation target defective pixel by the interpolation target defective pixel determining unit, the captured image as a composition target image and then
generates a composite image having a higher image quality than image quality of each of a plurality of the composition target images by performing composite processing using the plurality of composition target images.

9. The image processing device according to claim 8,
wherein the composite image has
a larger number of pixels than a number of pixels of each of the plurality of captured images.

10. The image processing device according to claim 8,
wherein the composite image has
a higher color resolution than a color resolution of each of the plurality of captured images.

11. The image processing device according to claim 6,
wherein a difference between pixels at positions corresponding to each other between each of the plurality of captured images and a defect-corrected image corresponding to the captured image among the plurality of defect-corrected images is calculated, and interpolation target defective pixel information is generated, the interpolation target defective pixel information indicating that a pixel whose difference is greater than or equal to a predetermined value is a defective pixel.

12. The image processing device according to claim 11, further comprising:
an association unit that associates the plurality of captured images with the interpolation target defective pixel information.

13. The image processing device according to claim 1,
wherein the plurality of captured images is
obtained by capturing images in a state in which positional relationships between the imaging range and the image sensor are caused to be different from each other by a pixel or a subpixel.

14. An image processing device comprising:
a defect candidate pixel detecting unit that detects a defect candidate pixel for each of captured images captured in a state where positional relationships between an imaging range and an image sensor comprising a plurality of pixels are caused to be different from each other by performing defect candidate pixel detecting processing on each of the plurality of captured images; and
an association unit that associates the captured images and a detection result of the defect candidate pixel detecting unit.

15. The image processing device according to claim 14,
wherein the detection result is
defect candidate pixel detection information indicating a number of times each pixel of the captured images is detected as the defect candidate pixel by the defect candidate pixel detecting unit.

16. The image processing device according to claim 14, further comprising:
an interpolation target defective pixel determining unit that determines, as an interpolation target defective pixel, a pixel detected as the defect candidate pixel a number of times greater than or equal to a threshold value by the defect candidate pixel detecting unit.

17. The image processing device according to claim 16,
wherein the detection result is
interpolation target defective pixel address information indicating an address of the interpolation target defective pixel.

18. The image processing device according to claim 6, further comprising:
an association unit that associates address difference information with the plurality of defect-corrected images, the address difference information indicating addresses of pixels, of a highest rank to a predetermined rank in a descending order of absolute values of differences among absolute values of a plurality of differences calculated for pixels at positions corresponding to each other in the plurality of captured images and the plurality of defect-corrected images, and the differences.

19. An image processing device comprising:
a pixel value restoring unit that restores a pixel value of a pixel in a plurality of captured images by using address difference information indicating an address of the pixel, an absolute value of a difference calculated for which at positions corresponding to each other in a plurality of defect-corrected images corresponding to one of the plurality of captured images and the plurality of captured images is greater than or equal to a predetermined value, and differences for the pixel and the plurality of defect-corrected images.

20. An image processing method of executing control of:
detecting a defect candidate pixel for each of a plurality of captured images captured in a state where positional relationships between an imaging range and an image sensor comprising a plurality of pixels are caused to be different from each other by performing defect candidate pixel detecting processing on each of the plurality of captured images; and
determining, as an interpolation target defective pixel, a pixel detected as the defect candidate pixel a number of times greater than or equal to a threshold value.

21. An image processing program of executing control of:
detecting a defect candidate pixel for each of captured images captured in a state where positional relationships between an imaging range and an image sensor comprising a plurality of pixels are caused to be different from each other by performing defect candidate pixel detecting processing on each of the plurality of captured images; and
determining, as an interpolation target defective pixel, a pixel detected as the defect candidate pixel a number of times greater than or equal to a threshold value.
